(19) United States
(12) Patent Application Publication
(10) Pub. No.: US 2026/0134111 A1
(43) Pub. Date: May 14, 2026

(54) METHOD AND APPARATUS FOR REPRODUCING INPUT DATA THAT TRIGGERS SOFTWARE VULNERABILITY, AND DEVICE AND MEDIUM

(71) Applicant: Tsinghua University, Beijing (CN)

(72) Inventors: Chao ZHANG, Beijing (CN); Songtao YANG, Beijing (CN)

(73) Assignee: Tsinghua University, Beijing (CN)

(21) Appl. No.: 19/433,928

(22) Filed: Dec. 28, 2025

Related U.S. Application Data
(63) Continuation of application No. PCT/CN2023/112328, filed on Aug. 10, 2023.

(30) Foreign Application Priority Data
Jun. 28, 2023 (CN) 202310781248.5

(51) Int. Cl. G06F 21/57; G06F 21/54

(52) U.S. Cl. CPC G06F 21/577; G06F 21/54

(57) ABSTRACT

The present application provides a method and apparatus for reproducing input data that triggers a software vulnerability, a device, and a medium. The method includes: identifying a plurality of old-version and new-version functions, and corresponding old-version and new-version static function call relationships, that are included respectively in an old-version binary program and a new-version binary program corresponding respectively to target software before and after a vulnerability is patched; obtaining old-version and new-version actual function call sequences corresponding respectively to the old-version and new-version binary programs during running; matching the old-version functions with the new-version functions to obtain matched function pairs; determining candidate patch functions from the matched function pairs; and performing fuzz testing on the old-version and new-version binary programs according to each candidate patch function and a second preset test case pool, to determine target input data that can trigger the vulnerability of the old-version binary program.

### CROSS-REFERENCE TO RELATED APPLICATION

This application is a continuation of International Application No. PCT/CN 2023/112328, filed on Aug. 10, 2023, which claims priority to Chinese patent application No. 202310781248.5, titled “METHOD AND APPARATUS FOR REPRODUCING INPUT DATA THAT TRIGGERS SOFTWARE VULNERABILITY, AND DEVICE AND MEDIUM” and filed with the China National Intellectual Property Administration on Jun. 28, 2023. The above applications are hereby incorporated by reference in their entireties.

### TECHNICAL FIELD

The present application relates to network security technologies, and more specifically, to a method and apparatus for reproducing input data that triggers a software vulnerability, a device, and a medium.

### BACKGROUND

Software vulnerabilities are a serious threat faced in the computer industry, and may affect end users, industry entities, and even national security. Therefore, it is of significant importance to discover software vulnerabilities and fix them in a timely manner, as well as to conduct advance protection against the attack characteristics of software vulnerabilities. In addition to vulnerabilities that have not been discovered in software, vulnerabilities for which software vendors have already released patches may also pose security threats. This is because attackers may analyze and locate vulnerabilities by comparing the software differences before and after the patches, while users may not immediately apply the patches after the patches are released.

At present, in order to protect user software from threats, an attack detection system may be deployed in a network system that hosts the user software. The attack traffic may be identified by detecting an attack characteristic byte sequence in the network traffic, thereby intercepting the attack in advance. In order to effectively detect the attack traffic, it is necessary to obtain input data that can trigger a vulnerability targeted by a patch. For software that fixes vulnerabilities by means of incremental update, a patch released by the software vendor may be directly analyzed to reproduce input data that can trigger the vulnerability targeted by the patch. However, for software that fixes vulnerabilities by means of full-package update, it is currently still not possible to efficiently reproduce input data that can trigger a fixed vulnerability.

### SUMMARY

The present application provides a method and apparatus for reproducing input data that triggers a software vulnerability, a device, and a medium, so as to solve the problem in the prior art that for software that fixes vulnerabilities by means of full-package update, it is impossible to efficiently reproduce input data that can trigger a fixed vulnerability.

In a first aspect, the present application discloses a method for reproducing input data that triggers a software vulnerability, including:
obtaining a plurality of old-version functions and an old-version static function call relationship included in an old-version binary program of target software before a vulnerability is patched, and obtaining a plurality of new-version functions and a new-version static function call relationship included in a new-version binary program of the target software after the vulnerability is patched;
obtaining an old-version actual function call sequence during running of a first test case by the old-version binary program, and obtaining a new-version actual function call sequence during running of the first test case by the new-version binary program; where the first test case belongs to a first preset test case pool;
determining an old-version currently-recovered function call relationship according to the old-version static function call relationship and the old-version actual function call sequence, and determining a new-version currently-recovered function call relationship according to the new-version static function call relationship and the new-version actual function call sequence;
matching the plurality of old-version functions with the plurality of new-version functions according to the old-version currently-recovered function call relationship and the new-version currently-recovered function call relationship, to obtain a plurality of matched function pairs; where a matched function pair includes an old-version function and a new-version function that match each other;
determining at least one candidate patch function from a plurality of matched old-version functions according to the old-version currently-recovered function call relationship and the new-version currently-recovered function call relationship;
performing fuzz testing on the old-version binary program and the new-version binary program according to each candidate patch function and a second preset test case pool, to determine target input data that is capable of triggering the vulnerability of the old-version binary program.

In a second aspect, the present application discloses an apparatus for reproducing input data that triggers a software vulnerability, including:
a first obtaining module, configured to obtain a plurality of old-version functions and an old-version static function call relationship included in an old-version binary program of target software before a vulnerability is patched, and obtain a plurality of new-version functions and a new-version static function call relationship included in a new-version binary program of the target software after the vulnerability is patched;
a second obtaining module, configured to obtain an old-version actual function call sequence during running of a first test case by the old-version binary program, and obtain a new-version actual function call sequence during running of the first test case by the new-version binary program; where the first test case belongs to a first preset test case pool;
a first determining module, configured to determine an old-version currently-recovered function call relationship according to the old-version static function call relationship and the old-version actual function call sequence, and determine a new-version currently-recovered function call relationship according to the new-version static function call relationship and the new-version actual function call sequence;
a matching module, configured to match the plurality of old-version functions with the plurality of new-version functions according to the old-version currently-recovered function call relationship and the new-version currently-recovered function call relationship, to obtain a plurality of matched function pairs; where a matched function pair includes an old-version function and a new-version function that match each other;
a second determining module, configured to determine at least one candidate patch function from a plurality of matched old-version functions according to the old-version currently-recovered function call relationship and the new-version currently-recovered function call relationship;
a third determining module, configured to perform fuzz testing on the old-version binary program and the new-version binary program according to each candidate patch function and a second preset test case pool, to determine target input data that is capable of triggering the vulnerability of the old-version binary program.

In a third aspect, the present application discloses an electronic device, including: a processor, and a memory communicatively connected to the processor;
the memory stores computer-executable instructions;
the processor executes the computer-executable instructions stored in the memory to implement the method as described in the first aspect.

In a fourth aspect, the present application discloses a computer-readable storage medium, where the computer-readable storage medium stores computer-executable instructions, and the computer-executable instructions, when executed by a processor, are used to implement the method as described in the first aspect.

In a fifth aspect, the present application discloses a computer program product including a computer program, and the method as described in the first aspect is implemented when the computer program is executed by a processor.

In combination with the above technical solutions, in the present application, a plurality of old-version functions and an old-version static function call relationship included in an old-version binary program of target software before a vulnerability is patched are obtained, and a plurality of new-version functions and a new-version static function call relationship included in a new-version binary program of the target software after the vulnerability is patched are obtained; an old-version actual function call sequence during running of a first test case by the old-version binary program is obtained, and a new-version actual function call sequence during running of the first test case by the new-version binary program is obtained, where the first test case belongs to a first preset test case pool; an old-version currently-recovered function call relationship is determined according to the old-version static function call relationship and the old-version actual function call sequence, and a new-version currently-recovered function call relationship is determined according to the new-version static function call relationship and the new-version actual function call sequence; the plurality of old-version functions are matched with the plurality of new-version functions according to the old-version currently-recovered function call relationship and the new-version currently-recovered function call relationship to obtain a plurality of matched function pairs, where a matched function pair includes an old-version function and a new-version function that match each other; at least one candidate patch function is determined from a plurality of matched old-version functions according to the old-version currently-recovered function call relationship and the new-version currently-recovered function call relationship; and fuzz testing is performed on the old-version binary program and the new-version binary program according to each candidate patch function and a second preset test case pool, to determine target input data that is capable of triggering the vulnerability of the old-version binary program. The old-version currently-recovered function call relationship can reflect the internal structure and characteristics of the old-version binary program, and the new-version currently-recovered function call relationship can reflect the internal structure and characteristics of the new-version binary program. Therefore, according to the old-version currently-recovered function call relationship and the new-version currently-recovered function call relationship, the plurality of old-version functions can be matched with the plurality of new-version functions to obtain the plurality of matched function pairs. Further, according to the old-version currently-recovered function call relationship and the new-version currently-recovered function call relationship, the candidate patch functions that possibly caused the old-version binary program to have the vulnerability can be determined from the matched old-version functions of the matched function pairs. Fuzz testing is then performed on the old-version binary program and the new-version binary program according to the candidate patch functions and the preset second test case pool, so that during the fuzz testing, the old-version binary program is more inclined to execute the candidate patch functions. This can increase the probability of reproducing, in the fuzz testing, the target input data that can trigger the vulnerability of the old-version binary program, and more efficiently reproduce the input data that can trigger the fixed vulnerability.

### BRIEF DESCRIPTION OF THE DRAWINGS

FIG. 1 is a network architecture diagram corresponding to an application scenario of a method for reproducing input data that triggers a software vulnerability according to an embodiment of the present application.

FIG. 2 is a schematic flowchart of a method for reproducing input data that triggers a software vulnerability according to Embodiment 1 of the present application.

FIG. 3 is a schematic diagram of an old-version currently-recovered function call relationship according to Embodiment 4 of the present application.

FIG. 4 is a schematic flowchart of a method for reproducing input data that triggers a software vulnerability according to Embodiment 6 of the present application.

FIG. 5 is a schematic flowchart of fuzz testing in the method for reproducing input data that triggers a software vulnerability according to Embodiment 6 of the present application.

FIG. 6 is a schematic structural diagram of an apparatus for reproducing input data that triggers a software vulnerability according to Embodiment 7 of the present application.

FIG. 7 is a schematic structural diagram of an electronic device according to Embodiment 8 of the present application.

### DESCRIPTIONS OF EMBODIMENTS

In the description of the embodiments of the present application, claims and drawings, terms such as “first”, “second”, “third”, “fourth”, and “fifth” are used to distinguish between similar objects, and are not necessarily for describing a specific order or sequence. It should be understood that the terms so used can be interchanged under appropriate circumstances, so that the embodiments of the present application described herein can be implemented in orders other than those illustrated or described herein. The terms “including” and “having” and any variations thereof are intended to cover non-exclusive inclusions. For example, a process, method, system, product, or device that includes a series of steps or units is not necessarily limited to those steps or units explicitly listed, but may include other steps or units that are not explicitly listed or are inherent to such process, method, product, or device. Furthermore, as used herein, the singular forms “a/an”, “one”, and “the” are intended to also include the plural forms. The terms “or”, “and/or”, “including at least one of”, etc., may be interpreted as being inclusive, or meaning any one or any combination. For example, “including at least one of: A, B, C” means “any of the following: A; B; C; A and B; A and C; B and C; and A, B, and C”. As another example, “A, B, or C” or “A, B and/or C” means “any of the following: A; B; C; A and B; A and C; B and C; and A, B, and C”. An exception to this definition occurs only when a combination of elements, functions, steps, or operations is in some way inherently mutually exclusive.

A detailed description and analysis of the prior art involved in the present application are provided below.

Software vulnerabilities are a serious threat faced in the computer industry, and may affect end users, industry entities, network security, etc. Therefore, it is of significant importance to discover software vulnerabilities and to fix them in a timely manner, as well as to conduct advance protection against the attack characteristics of software vulnerabilities. However, in addition to vulnerabilities that have not yet been discovered in software, vulnerabilities that have already been discovered and patched in software may also pose security threats. This is because users may not immediately apply a vulnerability patch after a software vendor releases the vulnerability patch, while attackers may analyze and locate the vulnerability by comparing the software difference before and after the patch. Therefore, for software for which a vulnerability has been patched, in a situation where a user has not immediately installed the software patch and is still using the unpatched software, if it is possible to reproduce input data that can trigger the software vulnerability, then an attack detection system can be deployed in the network system that hosts the user software, and the attack traffic can be identified by detecting the attack characteristic byte sequence in the network traffic, thereby intercepting the attack in advance, and protecting the network security of end users.

Since a software vendor will not publish specific information about the fixed vulnerability after patching the vulnerability, for a vulnerability patched by means of incremental update, by analyzing the patch released by the software vendor, it is possible to reproduce input data that can trigger the vulnerability targeted by the patch. However, for software that fixes vulnerabilities by means of full-package update, due to the large amount of code, the efficiency of analyzing a vulnerability by comparing the software difference before and after the patch and reproducing input data that can trigger the vulnerability targeted by the patch is low, and it is not possible to efficiently reproduce the input data that can trigger the fixed vulnerability.

Software fuzz testing is a mainstream method for discovering software vulnerabilities. Fuzz testing is to discover software vulnerabilities by constructing a large amount of random data, inputting it into the software under test, and monitoring for operational abnormalities of the software under test after the random data is input, such as a crash. However, most fuzz testing solutions do not consider the internal structure and characteristics of the software under test, and only the output and abnormal operating states of the software under test are observed, resulting in low efficiency for discovering vulnerabilities.

In summary, in the prior art, for software that fixes vulnerabilities by means of full-package update, there exist the problems of being unable to efficiently reproduce input data that can trigger the fixed vulnerability.

When facing the problems in the prior art, the inventors conduct creative research. In order to efficiently reproduce input data that can trigger a software vulnerability, it is necessary to consider the internal structure of software, and the function call relationship of a binary program can reflect the internal structure of target software. At the same time, patching of a software vulnerability will often change the function call relationship in the binary program. Therefore, the function call relationships of the old-version binary program and the new-version binary program can be recovered, and the function call relationships can be combined with fuzz testing, thereby more accurately and efficiently reproducing the input data that can trigger the fixed vulnerability.

Therefore, the inventors propose the technical solution of the present application, including: obtaining a plurality of old-version functions and an old-version static function call relationship included in an old-version binary program of target software before a vulnerability is patched, and obtaining a plurality of new-version functions and a new-version static function call relationship included in a new-version binary program of the target software after the vulnerability is patched; obtaining an old-version actual function call sequence during running of a first test case by the old-version binary program, and obtaining a new-version actual function call sequence during running of the first test case by the new-version binary program, where the first test case belongs to a first preset test case pool; determining an old-version currently-recovered function call relationship according to the old-version static function call relationship and the old-version actual function call sequence, and determining a new-version currently-recovered function call relationship according to the new-version static function call relationship and the new-version actual function call sequence; matching the plurality of old-version functions with the plurality of new-version functions according to the old-version currently-recovered function call relationship and the new-version currently-recovered function call relationship, to obtain a plurality of matched function pairs, where a matched function pair includes an old-version function and a new-version function that match each other; determining at least one candidate patch function from a plurality of matched old-version functions according to the old-version currently-recovered function call relationship and the new-version currently-recovered function call relationship; and performing fuzz testing on the old-version binary program and the new-version binary program according to each candidate patch function and a second preset test case pool, to determine target input data that is capable of triggering the vulnerability of the old-version binary program. The old-version currently-recovered function call relationship can reflect the internal structure and characteristics of the old-version binary program, and the new-version currently-recovered function call relationship can reflect the internal structure and characteristics of the new-version binary program. Therefore, according to the old-version currently-recovered function call relationship and the new-version currently-recovered function call relationship, the plurality of old-version functions can be matched with the plurality of new-version functions to obtain the plurality of matched function pairs. Further, according to the old-version currently-recovered function call relationship and the new-version currently-recovered function call relationship, the candidate patch functions that possibly caused the old-version binary program to have the vulnerability can be determined from the matched old-version functions of the matched function pairs. Fuzz testing is then performed on the old-version binary program and the new-version binary program according to the candidate patch functions and the preset second test case pool, so that during the fuzz testing, the old-version binary program is more inclined to execute the candidate patch functions. This can increase the probability of reproducing, in the fuzz testing, the target input data that can trigger the vulnerability of the old-version binary program, and more efficiently reproduce the input data that can trigger the fixed vulnerability.

The method and apparatus for reproducing input data that triggers a software vulnerability, the device and the medium that are provided by the present application are intended to solve the above technical problems in the prior art. The technical solution of the present application and how the technical solution of the present application solves the above technical problems will be described in detail below by means of specific embodiments. The several specific embodiments below can be combined with each other, and for the same or similar concepts or processes, the description thereof may not be repeated in some embodiments.

Network architectures and application scenarios of the method for reproducing input data that triggers a software vulnerability provided by the embodiments of the present application will be described below. When the following description refers to the drawings, unless otherwise indicated, the same data in different drawings represent the same or similar elements.

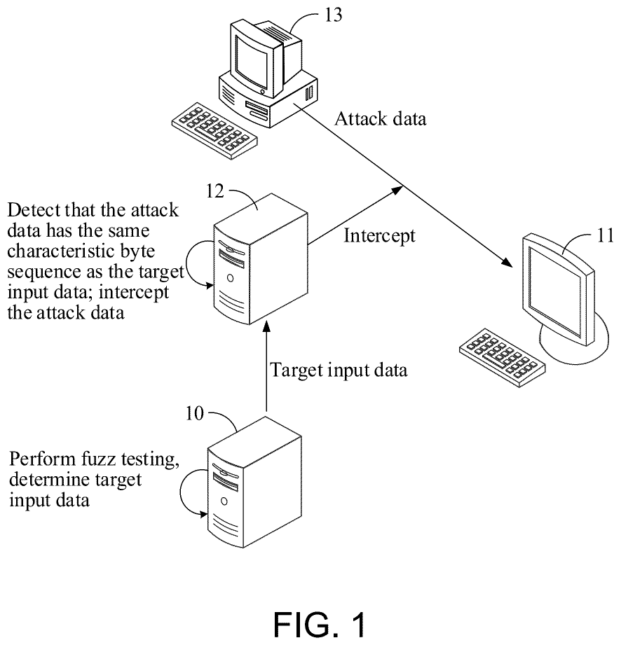

FIG. 1 is a network architecture diagram corresponding to an application scenario of a method for reproducing input data that triggers a software vulnerability according to an embodiment of the present application. As shown in FIG. 1, a network architecture corresponding to an application scenario provided in an embodiment of the present application includes: an electronic device 10, a user terminal 11, a cloud server 12, and an attack device 13.

The user terminal 11 is communicatively connected to the cloud server 12, and the cloud server 12 provides services such as computing and storage for the user terminal 11. Target software before a vulnerability is patched is installed on the user terminal 11.

The electronic device 10 obtains a plurality of old-version functions and an old-version static function call relationship included in an old-version binary program of the target software before the vulnerability is patched, and obtains a plurality of new-version functions and a new-version static function call relationship included in a new-version binary program of the target software after the vulnerability is patched.

The electronic device 10 obtains an old-version actual function call sequence during running of a first test case by the old-version binary program, and obtains a new-version actual function call sequence during running of the first test case by the new-version binary program; where the first test case belongs to a first preset test case pool.

The electronic device 10 determines an old-version currently-recovered function call relationship according to the old-version static function call relationship and the old-version actual function call sequence, and determines a new-version currently-recovered function call relationship according to the new-version static function call relationship and the new-version actual function call sequence.

The electronic device 10 matches the plurality of old-version functions with the plurality of new-version functions according to the old-version currently-recovered function call relationship and the new-version currently-recovered function call relationship, to obtain a plurality of matched function pairs; where a matched function pair includes an old-version function and a new-version function that match each other.

The electronic device 10 determines at least one candidate patch function from a plurality of matched old-version functions according to the old-version currently-recovered function call relationship and the new-version currently-recovered function call relationship.

The electronic device 10 performs fuzz testing on the old-version binary program and the new-version binary program according to each candidate patch function and a second preset test case pool, to determine target input data that is capable of triggering the vulnerability of the old-version binary program.

The electronic device 10 sends the target input data that is capable of triggering the vulnerability of the old-version binary program to the cloud server 12. In a process of the cloud server 12 providing services for the user terminal 11, if the attack device 13 attacks the user terminal 11 through the vulnerability of the old-version binary program, the attack data will have the same characteristic byte sequence as the target input data. Therefore, the cloud server 12 detects network traffic according to the characteristic byte sequence of the target input data, and intercepts the attack data having the same characteristic byte sequence as the target input data when the attack data is detected, thereby ensuring the network security of the user terminal.

The embodiments of the present application will be described below with reference to the drawings. The implementations described in the following embodiments do not represent all implementations consistent with the present application. Rather, they are merely examples of apparatuses and methods consistent with some aspects of the present application as detailed in the appended claims.

### Embodiment 1

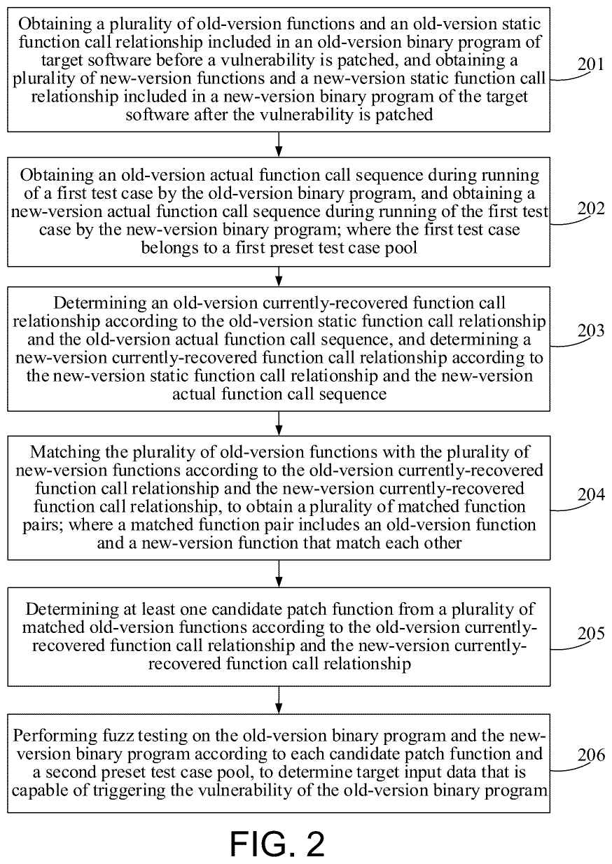

FIG. 2 is a schematic flowchart of a method for reproducing input data that triggers a software vulnerability according to Embodiment 1 of the present application. As shown in FIG. 2, an execution entity of the present application is an apparatus for reproducing input data that triggers a software vulnerability, and the apparatus for reproducing input data that triggers a software vulnerability is located in an electronic device. The method for reproducing input data that triggers a software vulnerability provided in this embodiment includes steps 201 to 206.

Step 201, obtaining a plurality of old-version functions and an old-version static function call relationship included in an old-version binary program of target software before a vulnerability is patched, and obtaining a plurality of new-version functions and a new-version static function call relationship included in a new-version binary program of the target software after the vulnerability is patched.

In some embodiments, in step 201, “obtaining a plurality of old-version functions and an old-version static function call relationship included in an old-version binary program of the target software before the vulnerability is patched” is refined to include step 201a, and “obtaining a plurality of new-version functions and a new-version static function call relationship included in a new-version binary program of the target software after the vulnerability is patched” is refined to include step 201b.

Step 201a, identifying the old-version binary program by using a static disassembler program, to obtain a plurality of old-version functions and an old-version static function call relationship.

Step 201b, identifying the new-version binary program by using the static disassembler program, to obtain a plurality of new-version functions and a new-version static function call relationship.

In this embodiment, the electronic device may use the static disassembler program to disassemble the old-version binary program of the target software before the vulnerability is patched and the new-version binary program of the target software after the vulnerability is patched, respectively, to obtain an old-version assembly program corresponding to the old-version binary program and a new-version assembly program corresponding to the new-version binary program. The static disassembler program may be pre-configured in the electronic device.

Further, the electronic device may identify the old-version assembly program and the new-version assembly program through the static disassembler program to obtain the plurality of old-version functions included in the old-version binary program, the old-version static function call relationship included in the old-version binary program, the plurality of new-version functions included in the new-version binary program, and the new-version static function call relationship included in the new-version binary program. Here, “new-version” and “old-version” are for the convenience of distinguishing and describing the binary programs, assembly programs, function call relationships, etc., of the target software before and after the vulnerability is patched, and should not be understood as a limitation on the technical solution of the present application.

In this embodiment, the static function call relationship may be a static function call relationship graph, or other data forms that can reflect the function call relationship in the program. The static function call relationship graph includes nodes and directed edges, and the nodes are connected through the directed edges. The nodes are used to represent functions included in the program, and the directed edges are used to represent static call relationships between the functions. A static call relationship is a function call relationship that can be directly identified from an assembly program, and usually includes a direct call relationship between functions.

Step 202, obtaining an old-version actual function call sequence during running of a first test case by the old-version binary program, and obtaining a new-version actual function call sequence during running of the first test case by the new-version binary program; where the first test case belongs to a first preset test case pool.

In this embodiment, the actual function call sequence refers to the functions that are actually called during the running of the binary program, and the call order of the actually called functions. The electronic device may arbitrarily select a first test case from the first preset test case pool, and input the first test case into the old-version binary program and the new-version binary program for running, respectively. The old-version actual function call sequence of the old-version binary program during the running of the first test case by the old-version binary program and the new-version actual function call sequence of the new-version binary program during the running of the first test case by the new-version binary program are recorded.

Specifically, the electronic device may obtain the old-version actual function call sequence and the new-version actual function call sequence through a preset dynamic instrumentation tool.

Step 203, determining an old-version currently-recovered function call relationship according to the old-version static function call relationship and the old-version actual function call sequence, and determining a new-version currently-recovered function call relationship according to the new-version static function call relationship and the new-version actual function call sequence.

In this embodiment, since errors may occur in the process of the static disassembler program converting a binary program into an assembly program, and indirect function calls cannot be identified from assembly language, the function calls included in the static function call relationship may have errors and omissions, and the static function call relationship does not necessarily include all function calls in the binary program accurately and completely. The actual function call sequence can reflect the function calls during the running of the program, and the actual function call sequence includes indirect function calls. Therefore, the electronic device may combine the old-version static function call relationship and the old-version actual function call sequence to determine the old-version currently-recovered function call relationship, and combine the new-version static function call relationship and the new-version actual function call sequence to determine the new-version currently-recovered function call relationship.

In some embodiments, in step 203, “determining an old-version currently-recovered function call relationship according to the old-version static function call relationship and the old-version actual function call sequence” is refined to include step 203a, and “determining a new-version currently-recovered function call relationship according to the new-version static function call relationship and the new-version actual function call sequence” is refined to include step 203b.

Step 203a, supplementing the old-version static function call relationship by using an actual function call relationship existing in the old-version actual function call sequence, to obtain the old-version currently-recovered function call relationship.

Step 203b, supplementing the new-version static function call relationship by using an actual function call relationship existing in the new-version actual function call sequence, to obtain the new-version currently-recovered function call relationship.

In this embodiment, the function calls included in the static function call relationship may have errors and omissions, whereas the function call relationship included in the actual function call sequence has definitely occurred actually during the running of the program. Therefore, it is still possible to obtain, according to the static function call relationship and the actual function call sequence, a currently-recovered function call relationship for the program which is more complete relative to the static function call relationship and the actual function call sequence, although the function call relationship included in the actual function call sequence may also be incomplete since the binary program will only execute one program path during the running of one test case.

Specifically, for the old-version binary program, the actual function call relationship existing in the old-version actual function call sequence may be used to supplement the old-version static function call relationship to obtain the old-version currently-recovered function call relationship. For the new-version binary program, the actual function call relationship existing in the new-version actual function call sequence may be used to supplement the new-version static function call relationship to obtain the new-version currently-recovered function call relationship.

In some embodiments, for the old-version binary program, the actual function call relationship existing in the old-version actual function call sequence may be used to correct an erroneous function call relationship in the old-version static function call relationship and to supplement the old-version static function call relationship, to obtain the old-version currently-recovered function call relationship. For the new-version binary program, the actual function call relationship existing in the new-version actual function call sequence may be used to correct an erroneous function call relationship in the new-version static function call relationship and to supplement the new-version static function call relationship, to obtain the new-version currently-recovered function call relationship.

Through the method for reproducing input data that triggers a software vulnerability provided in this embodiment, a more complete currently-recovered function call relationship can be obtained by using the actual function call relationship existing in the actual function call sequence to supplement the static function call relationship, which is beneficial for the subsequent determination of matched function pairs and candidate patch functions.

Step 204, matching the plurality of old-version functions with the plurality of new-version functions according to the old-version currently-recovered function call relationship and the new-version currently-recovered function call relationship, to obtain a plurality of matched function pairs; where a matched function pair includes an old-version function and a new-version function that match each other.

In this embodiment, the electronic device matches the plurality of old-version functions with the plurality of new-version functions, and finds the corresponding new-version functions in the new-version binary program for the old-version functions, to obtain a plurality of matched function pairs. Here, one matched function pair includes one old-version function and one new-version function, and the old-version function and the new-version function included in the matched function pair match each other.

It can be understood that, due to modifications to the program code of the target software, the number of old-version functions included in the old-version binary program may be different from the number of new-version functions included in the new-version binary program, therefore, not every old-version function has a matched new-version function, and not every new-version function has a matched old-version function.

Step 205, determining at least one candidate patch function from a plurality of matched old-version functions according to the old-version currently-recovered function call relationship and the new-version currently-recovered function call relationship.

In this embodiment, both the static function call relationship and the actual function call sequence can reflect the function calls in the binary program. However, a function call in the static function call relationship does not necessarily occur during the running of the program, while a function call in the actual function call sequence is a function call that actually occurs during the running of the program.

In this embodiment, patching of the vulnerability of the target software will change the program code of the target software, and the change in the program code will affect the function calls of the target software during its running. Therefore, input data that can cause the actual function call sequence of the new-version binary program during its running to be different from that of the old-version binary program during its running may possibly be the target input data that can trigger the vulnerability of the old-version binary program. Therefore, after the matched function pairs are determined, an old-version callee-function sequence set for each old-version function may be determined according to the old-version currently-recovered function call relationship, and a new-version callee-function sequence set for each new-version function may be determined according to the new-version currently-recovered function call relationship. A callee-function sequence set includes at least one callee-function sequence, and a callee-function sequence is a sequence of functions called by a function call instruction sequence on a program branch in a function.

In this embodiment, according to the old-version callee-function sequence sets of the matched old-version functions and the new-version callee-function sequence sets of the matched new-version functions in the matched function pairs, the electronic device can determine, from the plurality of matched old-version functions, candidate patch functions whose callee-function sequence sets are different from the new-version callee-function sequence sets of the corresponding matched new-version functions. Further, in the process of reproducing the target input data that triggers the vulnerability of the old-version binary program, as long as the old-version binary program is more inclined to execute the candidate patch functions, the target input data can be reproduced more efficiently. It should be understood that, even if the old-version binary program triggers a vulnerability during its execution, it does not mean that the triggered vulnerability is necessarily caused by the old-version binary program executing a candidate patch function.

Step 206, performing fuzz testing on the old-version binary program and the new-version binary program according to each candidate patch function and a second preset test case pool, to determine target input data that is capable of triggering the vulnerability of the old-version binary program.

In this embodiment, the second preset test case pool includes a plurality of preset test cases. By using the preset test cases in the second preset test case pool, and on the condition that the old-version binary program is more inclined to execute the candidate patch functions during its running, the electronic device performs fuzz testing on the old-version binary program and the new-version binary program to determine the target input data that is capable of triggering the vulnerability of the old-version binary program.

In this embodiment, during the fuzz testing, if the function call sequence of the old-version binary program is different from that of the new-version binary program when running the same test case, then this test case may be determined to be the target input data.

In the method for reproducing input data that triggers a software vulnerability provided by this embodiment, the plurality of old-version functions are matched with the plurality of new-version functions according to the old-version and new-version currently-recovered function call relationships to obtain a plurality of matched function pairs. The candidate patch functions that possibly caused the old-version binary program to have the vulnerability are then determined from the matched old-version functions. After that, fuzz testing is performed on the old-version binary program and the new-version binary program according to the candidate patch functions and the preset second test case pool, so that during the fuzz testing, the old-version binary program is more inclined to execute the candidate patch functions. This can increase the probability of reproducing, in the fuzz testing, the target input data that can trigger the vulnerability of the old-version binary program, and more efficiently reproduce the input data that can trigger the fixed vulnerability.

### Embodiment 2

In the method for reproducing input data that triggers a software vulnerability provided in this embodiment, on the basis of Embodiment 1, step 204 of “matching the plurality of old-version functions with the plurality of new-version functions according to the old-version currently-recovered function call relationship and the new-version currently-recovered function call relationship, to obtain a plurality of matched function pairs” is refined to include steps 301 to 303.

Step 301, determining matching information for each old-version function according to the old-version currently-recovered function call relationship.

Step 302, determining matching information for each new-version function according to the new-version currently-recovered function call relationship.

Step 303, matching the plurality of old-version functions with the plurality of new-version functions according to the matching information for each old-version function and the matching information for each new-version function, to obtain a plurality of matched function pairs.

In this embodiment, the matching information may include, but is not limited to, at least one of the following: the number of times being called, the number of times of call initiating, the quantity of each preset call instruction type when initiating calls, a caller function set when being called, or whether a called relationship actually exists.

Here, the number of times being called and the number of times of call initiating may be directly obtained from the currently-recovered function call relationship. For example, for an old-version function, the number of times the old-version function is called by other functions may be obtained from the old-version currently-recovered function call relationship as the number of times being called, and the number of times the old-version function calls other functions may be obtained from the old-version currently-recovered function call relationship as the number of times of call initiating.

The caller function set when a function is called may be obtained by forming, from the currently-recovered function call relationship, a set of functions that call this function.

The currently-recovered function call relationship may also include the call instruction type used when a function initiates a call. Further, the quantity of each preset call instruction type when a function initiates calls may be obtained by counting each preset call instruction type used when the function initiates calls in the currently-recovered function call relationship. Here, the call instruction type used when a function initiates a call may also be understood as the type of target operand when the function initiates a call, or, the addressing mode when the function initiates a call. Specifically, after the assembly program corresponding to the binary program is decompiled, the call instruction type may be determined according to a corresponding CALL Opcode in the assembly program when the function initiates a call.

A called relationship refers to a function being called by its caller function, and may be determined from the currently-recovered function call relationship, but the currently-recovered function call relationship is not necessarily accurate and complete, therefore, the called relationship does not necessarily occur actually when the program is running. However, the actual function call relationship actually occurs, therefore, it is possible to determine whether the called relationship actually occurs according to the function calls that actually occur in the actual function call relationship.

In the method for reproducing input data that triggers a software vulnerability provided in this embodiment, by combining multiple types of matching information, the plurality of old-version functions can be matched with the plurality of new-version functions more accurately.

In some embodiments, step 303 of “matching the plurality of old-version functions with the plurality of new-version functions according to the matching information for each old-version function and the matching information for each new-version function, to obtain a plurality of matched function pairs” is refined to include steps 401 to 404.

Step 401, matching the entry function of the old-version binary program with the entry function of the new-version binary program, to obtain a matched function pair.

In this embodiment, the entry function refers to the entry point of a program, and is also called the main function, often written as main( ). One program can only have one entry function. Since the old-version binary program and the new-version binary program are the binary programs corresponding to the target software before and after the vulnerability is patched, respectively, the entry function of the old-version binary program and the entry function of the new-version binary program are determined to be a matched function pair.

Step 402, calculating a matching value between each unmatched old-version function and each unmatched new-version function according to the matching information for each unmatched old-version function and the matching information for each unmatched new-version function.

In some embodiments, the matching information includes: the number of times being called, the number of times of call initiating, the quantity of each preset call instruction type when initiating calls, the caller function set when being called, and whether the called relationship actually exists. Step 402 of “calculating a matching value between each unmatched old-version function and each unmatched new-version function according to the matching information for each unmatched old-version function and the matching information for each unmatched new-version function” is refined to include steps 501 to 507.

In some embodiments, since the old-version functions and the new-version functions may be re-matched during the subsequent fuzz testing process, the matching information may also include: a matching value of an old-version function and a new-version function in a historical matching process.

Step 501, for any pair of an unmatched old-version function and an unmatched new-version function, performing the following operations: steps 502 to 507.

In this embodiment, caller and callee are call relationships between functions; a function that calls another function is a caller function, and a function that is called by another function is called a callee function. As an example, if function F1 calls function F2, then function F2 is the callee function of function F1, and function F1 is the caller function of function F2.

Step 502, determining a first matching score according to the number of times being called corresponding to the old-version function and the number of times being called corresponding to the new-version function.

In this embodiment, the first matching score may be the ratio of the minimum value to the maximum value in the numbers of times being called corresponding to the old-version function and the new-version function, respectively.

Step 503, determining a second matching score according to the number of times of call initiating corresponding to the old-version function and the number of times of call initiating corresponding to the new-version function.

In this embodiment, the second matching score may be the ratio of the minimum value to the maximum value in the numbers of times of call initiating corresponding to the old-version function and the new-version function, respectively.

As an example, if the number of times of call initiating for the unmatched old-version function is 1 and the number of times being called is 2, and the number of times of call initiating for the unmatched new-version function is 4 and the number of times being called is 5, then between this unmatched old-version function and unmatched new-version function, the first matching score is 2/5, and the second matching score is 1/4.

Step 504, determining a third matching score according to the quantity of each preset call instruction type corresponding to when the old-version function initiates calls and the quantity of each preset call instruction type corresponding to when the new-version function initiates calls.

In this embodiment, the third matching score may be the ratio of the sum of the minimum values—each of which is a minimum value of the quantities for a preset call instruction type that respectively correspond to when the old-version function and the new-version function initiate calls—plus one to the sum of the averages—each of which is an average of the quantities for a preset call instruction type that respectively correspond to when the old-version function and the new-version function initiate calls—plus one. That is, for each preset call instruction type, a minimum value is determined by comparing the quantity corresponding to the old-version function and the quantity corresponding to the new-version function. For each preset call instruction type, an average is calculated from the quantities corresponding to the old-version function and the new-version function.

As an example, preset call instruction types include a first call instruction type, a second call instruction type, and a third call instruction type. The quantities of the first, second, and third call instruction types corresponding to when the old-version function initiates calls are 0, 1, and 0, respectively, and the quantities of the first, second, and third call instruction types corresponding to when the new-version function initiates calls are 1, 2, and 1, respectively. Then, the sum of the minimum values, obtained by determining the minimum quantity for each preset call instruction type and then summing them together, is 0+1+0=1, the sum of the averages, obtained by calculating the average quantity for each preset call instruction type and summing those averages, is (0+1)/2+(1+2)/2+(0+1)/2=5/2, and the third matching score is (1+1)/(5/2+1)=4/7. Here, adding one to the sum of the minimum values and adding one to the sum of the averages are to perform type-based normalization processing on the minimum values and the averages, so that the calculated third matching score is more accurate.

Step 505, determining a fourth matching score according to the caller function set corresponding to when the old-version function is called and the caller function set corresponding to when the new-version function is called.

In some embodiments, the fourth matching score is a first preset numerical value or a second preset numerical value, and the first preset numerical value is greater than the second preset numerical value. Step 505 of “determining a fourth matching score according to the caller function set corresponding to when the old-version function is called and the caller function set corresponding to when the new-version function is called” is refined to include steps 601 to 602.

Step 601, in response to existence of a matched function pair between the caller function set corresponding to when the old-version function is called and the caller function set corresponding to when the new-version function is called, determining the fourth matching score to be the first preset numerical value.

Step 602, in response to absence of a matched function pair between the caller function set corresponding to when the old-version function is called and the caller function set corresponding to when the new-version function is called, determining the fourth matching score to be the second preset numerical value.

In this embodiment, the first preset numerical value may be 1, and the second preset numerical value may be 0. Since a function in the target software may possibly be called by a plurality of different caller functions, if there exist matched caller functions between the old-version function and the new-version function, then the fourth matching score between the old-version function and the new-version function may be determined to be the first preset numerical value. This is because functions that are called under matched functions are more likely to match each other.

In the method for reproducing input data that triggers a software vulnerability provided in this embodiment, since the fourth matching score is determined to be the first preset numerical value when there exists a matched function pair between the caller function sets corresponding to when the old-version function and the new-version function are called, respectively, the plurality of old-version functions can be matched with the plurality of new-version functions more accurately.

Step 506, determining a fifth matching score according to whether the called relationship of the old-version function actually exists and the called relationship of the new-version function actually exists.

In some embodiments, the fifth matching score is a third preset numerical value or a fourth preset numerical value, and the third preset numerical value is greater than the fourth preset numerical value. Step 506 of “determining a fifth matching score according to whether the called relationship of the old-version function actually exists and whether the called relationship of the new-version function actually exists” is refined to include steps 701 to 702.

Step 701, in response to existence of the called relationship of the old-version function in the old-version actual function call sequence, and existence of the called relationship of the new-version function in the new-version actual function call sequence, determining the fifth matching score to be the third preset numerical value.

Step 702, in response to absence of the called relationship of the old-version function in the old-version actual function call sequence, or, absence of the called relationship of the new-version function in the new-version actual function call sequence, determining the fifth matching score to be the fourth preset numerical value.

In this embodiment, a callee function is not necessarily called during the running of the program, but if the callee function is actually called during the running, then the callee function will exist in the actual function call sequence. Therefore, it is necessary to determine whether the caller function of the old-version function actually called the old-version function during the running of the program, and whether the caller function of the new-version function actually called the new-version function during the running of the program.

In this embodiment, between the unmatched old-version function and the unmatched new-version function, if the called relationships corresponding to the two exist in their corresponding actual function call sequences, then it can be considered that the possibility of the two matching each other is higher. Conversely, if the situations of actual occurrences of their corresponding called relationships are different, or, if neither of their corresponding called relationships have actually occurred, then it can be considered that the possibility of the two matching each other is lower.

Therefore, when the called relationship of the old-version function exists in the old-version actual function call sequence, and the called relationship of the new-version function exists in the new-version actual function call sequence, the fifth matching score is determined to be the third preset numerical value. When the called relationship of the old-version function does not exist in the old-version actual function call sequence, or, the called relationship of the new-version function does not exist in the new-version actual function call sequence, the fifth matching score is determined to be the fourth preset numerical value. Here, the third preset numerical value may be 1, and the fourth preset numerical value may be 0.

In the method for reproducing input data that triggers a software vulnerability provided in this embodiment, since the fifth matching score is determined according to whether the function call relationships exist in the actual function call sequences, the plurality of new-version functions can be matched with the plurality of old-version functions according to the actual running situations of the old-version binary program and the new-version binary program, and a more accurate matched function pair can be obtained.

Step 507, performing a weighted sum calculation on the first matching score, the second matching score, the third matching score, the fourth matching score, and the fifth matching score according to their corresponding preset weights, to obtain the matching value between the unmatched old-version function and the unmatched new-version function.

In this embodiment, the first matching score, the second matching score, the third matching score, the fourth matching score, and the fifth matching score may correspond to different preset weights, respectively, so as to facilitate adjusting the preset weight corresponding to each matching score in the process of matching the plurality of old-version functions with the plurality of new-version functions, thereby matching the plurality of old-version functions with the plurality of new-version functions more accurately. It should be noted that the above five matching scores are taken as an example for illustration, and those skilled in the art can use any combination of these matching scores and other matching scores that can be obtained based on the concept of the present application.

In the method for reproducing input data that triggers a software vulnerability provided in this embodiment, since the matching value between the unmatched old-version function and the unmatched new-version function is calculated from different perspectives of multiple types of matching information, and a weighted sum calculation is performed on the first to fifth matching scores according to their corresponding preset weights, the matching value between the old-version function and the new-version function can be calculated accurately.

Step 403, determining a pair of an unmatched old-version function and an unmatched new-version function with the highest matching value to be a matched function pair.

In this embodiment, the level of the matching value can reflect the degree of matching between the old-version function and the new-version function, therefore, the pair of the unmatched old-version function and the unmatched new-version function with the highest matching value is determined to be a matched function pair. It can be understood that the old-version function in the matched function pair is a matched old-version function, and the new-version function in the matched function pair is a matched new-version function. Neither the matched old-version functions nor the matched new-version functions participates in the next round of matching degree calculation.

Step 404, repeating the step of calculating a matching value between each unmatched old-version function and each unmatched new-version function and the step of determining a pair of an unmatched old-version function and an unmatched new-version function with the highest matching value to be a matched function pair, until there is no unmatched old-version function, or, until there is no unmatched new-version function, to obtain a plurality of matched function pairs.

In this embodiment, a matching value between an unmatched old-version function and an unmatched new-version function may possibly change each time after a matched function pair is determined, therefore, upon each determination of a matched function pair, it is necessary to recalculate the matching value between each unmatched old-version function and each unmatched new-version function, and determine a pair of an unmatched old-version function and an unmatched new-version function with the currently highest matching value to be a matched function pair, thereby enabling more accurate matching of the plurality of old-version functions with the plurality of new-version functions.

In the method for reproducing input data that triggers a software vulnerability provided in this embodiment, the matching value is calculated according to the matching information of each unmatched function and can reflect whether an old-version function and a new-version function match, therefore, by determining the pair of the unmatched old-version function and the unmatched new-version function with the highest matching value to be a matched function pair, the plurality of new-version functions can be matched with the plurality of old-version functions accurately.

### Embodiment 3

In the method for reproducing input data that triggers a software vulnerability provided in this embodiment, on the basis of any one of the above embodiments, step 205 of “determining at least one candidate patch function from a plurality of matched old-version functions according to the old-version currently-recovered function call relationship and the new-version currently-recovered function call relationship” is refined to include steps 801 to 803.

Step 801, determining an old-version callee-function sequence set for the old-version function in each matched function pair according to the old-version currently-recovered function call relationship; where the old-version callee-function sequence set includes at least one old-version callee-function sequence, and an old-version callee-function sequence is a sequence of functions called by a function call instruction sequence on a program branch in the old-version function.

In this embodiment, the old-version currently-recovered function call relationship includes function calls and the instructions that initiate the function calls. As an example, if the old-version currently-recovered function call relationship is a function call relationship graph, and function F1 and function F2 are connected by a directed edge pointing from function F1 to function F2, then the instruction that calls function F2 is recorded on the directed edge. The instruction that calls the function may be obtained by analyzing the assembly program, or may be obtained during the running of the program.

It can be understood that one function may have a plurality of program branches, therefore, one function may have a plurality of callee-function sequences, and further, one function corresponds to one callee-function sequence set.

Step 802, determining a new-version callee-function sequence set for the new-version function in each matched function pair according to the new-version currently-recovered function call relationship; where the new-version callee-function sequence set includes at least one new-version callee-function sequence, and the new-version callee-function sequence is a sequence of functions called by a function call instruction sequence on a program branch in the new-version function.

In this embodiment, for determining the new-version callee-function sequence set for the new-version function in each matched function pair, reference can be made to the manner of determining the old-version callee-function sequence set for the old-version function in each matched function pair, and the description thereof is not repeated here.

Step 803, in response to existence of a difference between the old-version callee-function sequence set of the old-version function and the new-version callee-function sequence set of the new-version function in a matched function pair, determining the old-version function in the matched function pair to be a candidate patch function.

In this embodiment, if there are different callee functions in the callee-function sequences, or, if the order of the callee functions is different, then the callee-function sequences are different. If there exist an old-version callee-function sequence in the old-version callee-function sequence set and a new-version callee-function sequence in the new-version callee-function sequence set that are different, then the callee-function sequence sets are different.

As an example, an old-version callee-function sequence includes functions F1, F2, and F3, and the order in which functions F1, F2 and F3 are called is F1, F2, and F3. If a new-version callee-function sequence includes functions F1, F2, and F3, and the order in which functions F1, F2, and F3 are called is F1, F2, and F3, then the old-version callee-function sequence is the same as the new-version callee-function sequence. If a new-version callee-function sequence includes functions F1, F2, and F3, and the order in which functions F1, F2, and F3 are called is F1, F3, and F2, then the old-version callee-function sequence is different from the new-version callee-function sequence. If a new-version callee-function sequence includes functions F1, F2, and F4, and the order in which functions F1, F2, and F4 are called is F1, F2, and F4, then the old-version callee-function sequence is different from the new-version callee-function sequence.

In the method for reproducing input data that triggers a software vulnerability provided in this embodiment, by comparing the callee-function sequence sets of the old-version function and the new-version function in the matched function pair, the candidate patch function(s) that may trigger the vulnerability can be determined.

### Embodiment 4

In the method for reproducing input data that triggers a software vulnerability provided in this embodiment, on the basis of any one of the above embodiments, the second preset test case pool includes a plurality of initial test cases, and the initial test cases can be successfully run by the new-version binary program and the old-version binary program. Step 206 of “performing fuzz testing on the old-version binary program and the new-version binary program according to each candidate patch function and a second preset test case pool, to determine target input data that is capable of triggering the vulnerability of the old-version binary program” is refined to include step 901.

Step 901, performing a first traversal on the initial test cases, and performing a first operation once each time an initial test case is traversed during the first traversal.

The first operation includes: steps 9011 to 9018.

Step 9011, mutating the initial test case according to a preset mutation time and a preset mutation method, to obtain a plurality of mutated test cases corresponding to the initial test case.

In this embodiment, the preset mutation time may be any suitable time, and the preset mutation method may be any suitable mutation method. Each initial test case can be mutated to generate a plurality of mutated test cases.

Step 9012, using the old-version binary program to run each mutated test case, and determining whether each mutated test case runs successfully in the old-version binary program.

Step 9013, in response to any mutated test case running successfully in the old-version binary program, obtaining an old-version post-mutation function call sequence and an old-version post-mutation program execution path during running of the mutated test case by the old-version binary program.

In this embodiment, a mutated test case may be used as input data and input into the old-version binary program to run. If the old-version binary program becomes unresponsive, reports an error or is otherwise unanalyzable, then the running fails. If the running is successful, then the old-version post-mutation function call sequence and the old-version post-mutation program execution path may be obtained.

The old-version post-mutation function call sequence refers to: the functions called by the old-version binary program during running of a mutated test case, and the order of the called functions.

The old-version post-mutation program execution path includes: the program branches actually executed by the old-version binary program during running of a mutated test case. Here, since the target software may include a plurality of branches, the binary program of the target software may choose to execute different branches during its running according to different input data, results of conditional decision, etc. As an example, if the program includes conditional decision such as an if-else statement, different branches will be executed when the condition is true and when the condition is false; if the program includes conditional decision such as a switch statement, different branches will be executed when the conditions are different.

In this embodiment, the electronic device may obtain the old-version post-mutation function call sequence and the old-version post-mutation program execution path by performing instrumentation tracking on the process of the old-version binary program running each preset test case, analyzing the run log of the old-version binary program, and/or by other means.

Step 9014, using the new-version binary program to run each mutated test case, and determining whether each mutated test case runs successfully in the new-version binary program.

Step 9015, in response to any mutated test case running successfully in the new-version binary program, obtaining a new-version post-mutation function call sequence and a new-version post-mutation program execution path during running of the mutated test case by the new-version binary program.

Step 9014 and step 9015 are similar to step 9012 and step 9013, and the description thereof is not repeated here.

Step 9016, in response to any mutated test case running successfully in both the old-version binary program and the new-version binary program, determining the mutated test case to be a candidate test case.

In this embodiment, since the new-version binary program is the updated old-version binary program, for the same mutated test case, the situations of whether it runs successfully in the old-version binary program and the new-version binary program may be different, and only the mutated test case that runs successfully in both the old-version binary program and the new-version binary program could possibly be input data that triggers the vulnerability of the old-version binary program.

Step 9017, determining an order for performing a second traversal on candidate test cases according to the old-version post-mutation program execution path corresponding to each candidate test case and the candidate patch function.

In this embodiment, in order to determine the target input data from the candidate test cases, it is necessary to traverse the candidate test cases, and compare the old-version post-mutation function call sequence and the new-version post-mutation function call sequence corresponding to each candidate test case during the traversal. In order to improve the efficiency of reproducing the target input data, based on the principle that the easier it is to execute to a candidate patch function, the easier it is to trigger a vulnerability, the order for performing the second traversal on the candidate test cases is determined according to the old-version post-mutation program execution path corresponding to each candidate test case and the candidate patch function(s). If a candidate test case makes it easier for the old-version binary program to execute to a candidate patch function, then that candidate test case is traversed earlier.

In this embodiment, the order for traversing the candidate test cases can be determined according to the total distance between the old-version post-mutation program execution path corresponding to each candidate test case and the candidate patch functions.

Step 9018, performing the second traversal on the candidate test cases according to the order for performing the second traversal on the candidate test cases, and performing a second operation once each time a candidate test case is traversed during the second traversal.

The second operation includes step 90181.

Step 90181, determining whether the candidate test case is the target input data according to the old-version post-mutation function call sequence and the new-version post-mutation function call sequence corresponding to the candidate test case.

In this embodiment, patching of the vulnerability will change the function call relationship, therefore, if the old-version post-mutation function call sequence and the new-version post-mutation function call sequence corresponding to a candidate test case are different, for example, the functions included in the function call sequences are different or the function call order in the function call sequences is different, then it can be determined that the candidate test case is the target input data.

In the method for reproducing input data that triggers a software vulnerability provided in this embodiment, the efficiency of obtaining the target input data can be improved since the candidate patch functions can influence the traversal order during the fuzz testing.

In some embodiments, step 90181 of “determining whether the candidate test case is the target input data according to the old-version post-mutation function call sequence and the new-version post-mutation function call sequence corresponding to the candidate test case” is refined to include steps 1001 to 1002.

Step 1001, determining an old-version end-segment function call sequence of the old-version post-mutation function call sequence, and determining a new-version end-segment function call sequence of the new-version post-mutation function call sequence.

In this embodiment, the end-segment function call sequence refers to a preset number of functions that are last called by the binary program during its running.

Step 1002, in response to the old-version end-segment function call sequence being different from the new-version end-segment function call sequence, determining the candidate test case to be the target input data.

In this embodiment, the old-version post-mutation function call sequence and the new-version post-mutation function call sequence are relatively long, and during the running of the program, the end-segment function call sequences can better reflect the difference in the function call sequences of the program. Therefore, by comparing the end-segment function call sequences, if the end-segment function call sequences of the old-version binary program and the new-version binary program are different given the same input data, then it can be considered that this input data has triggered the vulnerability in the old-version binary program, thereby enabling more efficient determination of the target input data.

In some embodiments, “using the old-version binary program to run each mutated test case” in step 9012 is refined to include step 9012a, “determining an old-version end-segment function call sequence of the old-version post-mutation function call sequence” in step 1001 is refined to include step 1001a, “using the new-version binary program to run each mutated test case” in step 9014 is refined to include step 9014a, and “determining a new-version end-segment function call sequence of the new-version post-mutation function call sequence” in step 1001 is refined to include step 1001b.

Step 9012a, using a first circular array to record function calls during running of the mutated test case by the old-version binary program.

Step 1001a, determining the function calls recorded in the first circular array to be the old-version end-segment function call sequence according to an order from head to tail.

Step 9014a, using a second circular array to record function calls during running of the mutated test case by the new-version binary program; where the length of the second circular array is the same as the length of the first circular array.

Step 1001b, determining the function calls recorded in the second circular array to be the new-version end-segment function call sequence according to an order from head to tail.

In this embodiment, since a circular array can record ordered data of a fixed length, when using a circular array to record a post-mutation function call sequence, if the length of the function call sequence exceeds the length of the circular array, the circular array can directly implement the updating of the end-segment function call sequence. By using a circular array to record the post-mutation function call sequence when the binary program runs a mutated test case, after the binary program finishes running, the old-version end-segment function call sequence and the new-version end-segment function call sequence can be more efficiently determined directly according to the data stored in the circular array.

In some embodiments, step 9017 of “determining an order for performing a second traversal on candidate test cases according to the old-version post-mutation program execution path corresponding to each candidate test case and the candidate patch function” is refined to include steps 1101 to 1102.

Step 1101, calculating an execution distance between the old-version post-mutation program execution path corresponding to each candidate test case and each candidate patch function. In this embodiment, the program execution path includes the functions actually called during the running of the program. A candidate patch function may possibly not be actually called by the old-version binary program during the running of the mutated test case. When the old-version post-mutation program execution path includes a candidate patch function, the execution distance between the old-version post-mutation program execution path and the candidate patch function may be 0. When the old-version post-mutation program execution path does not include a candidate patch function, the execution distance between the old-version post-mutation program execution path and the candidate patch function may be determined to be the minimum value among the distances between the functions on the old-version post-mutation program execution path and the candidate patch function, according to the old-version currently-recovered function call relationship.

Step 1102, determining the order for performing the second traversal on the candidate test cases according to the execution distance between the old-version post-mutation program execution path corresponding to each candidate test case and each candidate patch function.

In some embodiments, step 1102 of “determining the order for performing the second traversal on the candidate test cases according to the execution distance between the old-version post-mutation program execution path corresponding to each candidate test case and each candidate patch function” is refined to include steps 11021 to 11022.

Step 11021, performing, for each candidate test case, a summation calculation on execution distances between the old-version post-mutation program execution path and candidate patch functions, to obtain corresponding candidate distances of the candidate test cases;

Step 11022, determining the order for performing the second traversal on the candidate test cases as the ascending order of the corresponding candidate distances.

In this embodiment, a smaller sum obtained by performing the summation calculation on the execution distances between the old-version post-mutation program execution path corresponding to a candidate test case and the candidate patch functions indicates that the candidate test case can make the old-version binary program more inclined to execute to more candidate patch functions. Therefore, the order for performing the second traversal on the candidate test cases is determined as the order of the execution distances between the old-version post-mutation program execution path corresponding to each candidate test case and each candidate patch function from small to large, or in other words from near to far, so as to make it more inclined to execute to the candidate patch functions during the fuzz testing and improve the efficiency of reproducing the target input data.

In some embodiments, step 1101 of “calculating an execution distance between the old-version post-mutation program execution path corresponding to each candidate test case and each candidate patch function” is refined to include steps 1201 to 1204.

Step 1201, for an old-version post-mutation program execution path and a candidate patch function, obtaining a predecessor function of the candidate patch function on the old-version post-mutation program execution path; where the predecessor function exists on the old-version post-mutation program execution path and is the one whose distance of executing to the candidate patch function is shortest among caller functions of the candidate patch function.

In this embodiment, the predecessor function is a caller function of a candidate patch function, which is on the old-version post-mutation program execution path and is closest to the candidate patch function in distance. Specifically, source tracing may be performed on the candidate patch function in an old-version complete function relationship graph, to find the predecessor function of the candidate patch function on the old-version post-mutation program execution path.

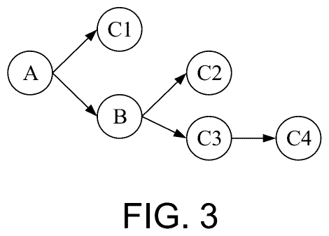

As an example, FIG. 3 is a schematic diagram of an old-version currently-recovered function call relationship according to Embodiment 4 of the present application. As shown in FIG. 3, the old-version binary program includes function A, function B, function C1, function C2, function C3, and function C4. Function A can call function B and function C1, function B can call function C2 and function C3, and function C3 can call function C4. If the old-version post-mutation program execution path during the old-version binary program running a mutated test case includes function A, function B, and function C2, then the predecessor function of function C3 on the old-version post-mutation program execution path is function B.

Step 1202, calculating a first distance of executing from the entry function of the old-version binary program to the predecessor function along the old-version post-mutation program execution path.

In this embodiment, the first distance refers to the distance of executing from the entry function to the predecessor function during the running of the program. The first distance may be the sum of jump distances of all functions on the path of executing from the entry function to the predecessor function. The jump distance of each function may be a unit distance of 1, or may be an adjacency distance. The adjacency distance is the sum of one and the reciprocal of twice the number of next functions called within that function.

Step 1203, calculating a second distance of executing from the predecessor function to the candidate patch function.

In this embodiment, the second distance refers to the distance of executing from the predecessor function to the candidate patch function, which is determined from the old-version currently-recovered function call relationship. The second distance may be the sum of jump distances of all functions on the path of executing from the predecessor function to the candidate patch function.

As an example, when the jump distance of each function is a unit distance of 1, in the old-version currently-recovered function call relationship as shown in FIG. 3, the first distance of executing from function A to function B is the jump distance of function A, which is 1; the first distance of executing from function A to function C2 is the sum of the jump distances of function A and function B, which is 2.

Step 1204, determining a sum of the first distance and the second distance to be the execution distance between the old-version post-mutation program execution path and the candidate patch function.

In this embodiment, the execution distance may be the sum of the first distance and the second distance. Continuing the description based on the example above, as shown in FIG. 3, if the old-version post-mutation program execution path corresponding to a mutated test case is the path where function A, function B, and function C2 are located, and function C3 is a candidate patch function, then the predecessor function of function C3 is function B, and the execution distance between the old-version post-mutation program execution path and function C3 may be the sum of the first distance from function A to function B and the second distance from function B to function C3. If the first distance from function A to function B is 1, and the second distance from function B to function C3 is 1, then the execution distance between the old-version post-mutation program execution path and function C3 is 2.

In the method for reproducing input data that triggers a software vulnerability provided in this embodiment, by first obtaining the predecessor function of the candidate patch function on the old-version post-mutation program execution path, and then calculating the execution distance between the old-version post-mutation program execution path and the candidate patch function through the first distance between the entry function and the predecessor function as well as the distance between the predecessor function and the candidate patch function, the execution distance between the old-version post-mutation program execution path and the candidate patch function can be calculated accurately, which thus facilitates the subsequent determination of whether the mutated test case can cause the old-version binary program to execute to the candidate patch function as much as possible, based on the execution distance between the old-version post-mutation program execution path and the candidate patch function.

In some embodiments, before step 901 of “performing a first traversal on the initial test cases, and performing a first operation once each time an initial test case is traversed during the first traversal”, the method further includes steps 1301 to 1302, and “performing a first traversal on the initial test cases” in step 901 is refined to include step 901a.

Step 1301, obtaining an old-version initial program execution path corresponding to each initial test case.

Step 1302, determining an order for performing the first traversal on the initial test cases according to the old-version initial program execution path corresponding to each initial test case and each candidate patch function.

Step 901a, performing the first traversal on the initial test cases according to the order for performing the first traversal on the initial test cases.

In this embodiment, since each initial test case included in the second preset test case pool can be successfully run by the new-version binary program and the old-version binary program, the electronic device may have an old-version initial program execution path during the old-version binary program running each initial test case pre-stored therein. Alternatively, the electronic device may use the old-version binary program to run each initial test case to obtain the old-version initial program execution path corresponding to each initial test case.

In this embodiment, the order for performing the first traversal on the initial test cases may be determined according to the execution distance between the old-version initial program execution path corresponding to each initial test case and each candidate patch function. For the manner of calculating the execution distance between each old-version initial program execution path and each candidate patch function, reference can be made to the manner of calculating the execution distance between the old-version post-mutation program execution path and each candidate patch function, and the description thereof is not repeated here.

In this embodiment, the electronic device can determine the order for performing the first traversal on the initial test cases to be the ascending order of the execution distances between the old-version initial program execution paths and the candidate patch functions, so as to increase the probability that a mutated test case corresponding to an initial test case will execute to a candidate patch function when running in the old-version binary program, thereby determining the target input data more efficiently.

### Embodiment 5

In the method for reproducing input data that triggers a software vulnerability provided in this embodiment, on the basis of Embodiment 4, after step 9013 of “in response to any mutated test case running successfully in the old-version binary program, obtaining an old-version post-mutation function call sequence and an old-version post-mutation program execution path during running of the mutated test case by the old-version binary program”, the method further includes steps 1401 to 1403.

Step 1401, for any mutated test case that runs successfully in the old-version binary program, performing the following operations: steps 1402 to 1403.

Step 1402, determining whether the old-version post-mutation program execution path triggers new code coverage for the old-version binary program.

Step 1403, in response to the old-version post-mutation program execution path triggering the new code coverage for the old-version binary program, adding the mutated test case to the second preset test case pool as an initial test case.

In this embodiment, in order to improve the code coverage of the fuzz testing for the old-version binary program, if the old-version post-mutation program execution path corresponding to a mutated test case that runs successfully in the old-version binary program triggers new code coverage in the old-version binary program, then the mutated test case is added to the second preset test case pool as an initial test case, so as to update the second preset test case pool. The updated second preset test case pool can be used for the next round of fuzz testing.

In some embodiments, after step 9013 of “in response to any mutated test case running successfully in the old-version binary program, obtaining an old-version post-mutation function call sequence and an old-version post-mutation program execution path during running of the mutated test case by the old-version binary program”, the method further includes steps 1501 to 1503.

Step 1501, for any mutated test case that runs successfully in the old-version binary program, performing the following operations: steps 1502 to 1503.

Step 1502, determining whether an old-version new function call relationship that does not exist in the old-version currently-recovered function call relationship exists in the old-version post-mutation function call sequence.

Step 1503, in response to existence of the old-version new function call relationship in the old-version post-mutation function call sequence, adding the mutated test case to the second preset test case pool as an initial test case.

In this embodiment, an old-version new function call relationship that does not exist in the old-version currently-recovered function call relationship may be used to update the currently-recovered function call relationship, which then changes the matching between the old-version functions and the new-version functions, and changes the candidate patch functions. Therefore, if an old-version new function call relationship that does not exist in the old-version currently-recovered function call relationship exists in the old-version post-mutation function call sequence corresponding to a mutated test case that runs successfully in the new-version binary program, then it is necessary to add the mutated test case to the second preset test case pool, so as to update the second preset test case pool. The updated second preset test case pool can be used for the next round of fuzz testing.

In some embodiments, after step 1502 of “determining whether an old-version new function call relationship that does not exist in the old-version currently-recovered function call relationship exists in the old-version post-mutation function call sequence”, the method further includes step 1601.

Step 1601, in response to the existence of the old-version new function call relationship in the old-version post-mutation function call sequence, supplementing the old-version currently-recovered function call relationship by using the old-version new function call relationship.

In this embodiment, since there exists the old-version new function call relationship in the old-version post-mutation function call sequence, the old-version new function call relationship can be used to supplement the old-version currently-recovered function call relationship, so as to obtain a more complete old-version currently-recovered function call relationship, thereby enabling more accurate matching of the old-version functions and the new-version functions.

In some embodiments, after step 9015 of “in response to any mutated test case running successfully in the new-version binary program, obtaining a new-version post-mutation function call sequence and a new-version post-mutation program execution path during running of the mutated test case by the new-version binary program”, the method further includes steps 1701 to 1703.

Step 1701, for any mutated test case that runs successfully in the new-version binary program, performing the following operations: steps 1702 to 1703.

Step 1702, determining whether the new-version post-mutation program execution path triggers new code coverage for the new-version binary program.

Step 1703, in response to the new-version post-mutation program execution path triggering the new code coverage for the new-version binary program, adding the mutated test case to the second preset test case pool as an initial test case.

In this embodiment, in order to improve the code coverage of the fuzz testing for the new-version binary program, if the new-version post-mutation program execution path corresponding to a mutated test case that runs successfully in the new-version binary program triggers new code coverage in the new-version binary program, then the mutated test case is added to the second preset test case pool as an initial test case, so as to update the second preset test case pool. The updated second preset test case pool can be used for the next round of fuzz testing.

In some embodiments, after step 9015 of “in response to any mutated test case running successfully in the new-version binary program, obtaining a new-version post-mutation function call sequence and a new-version post-mutation program execution path during running of the mutated test case by the new-version binary program”, the method further includes steps 1801 to 1803.

Step 1801, for any mutated test case that runs successfully in the new-version binary program, performing the following operations: steps 1802 to 1803.

Step 1802, determining whether a new-version new function call relationship that does not exist in the new-version currently-recovered function call relationship exists in the new-version post-mutation function call sequence.

Step 1803, in response to existence of the new-version new function call relationship in the new-version post-mutation function call sequence, adding the mutated test case to the second preset test case pool as an initial test case.

In this embodiment, a new-version new function call relationship that does not exist in the new-version currently-recovered function call relationship may be used to update the currently-recovered function call relationship, which then changes the matching between the old-version functions and the new-version functions, and changes the candidate patch functions. Therefore, if a new-version new function call relationship that does not exist in the new-version currently-recovered function call relationship exists in the new-version post-mutation function call sequence corresponding to a mutated test case that runs successfully in the new-version binary program, then it is necessary to add the mutated test case to the second preset test case pool, so as to update the second preset test case pool. The updated second preset test case pool can be used for the next round of fuzz testing.

In some embodiments, after step 1802 of “determining whether a new-version new function call relationship that does not exist in the new-version currently-recovered function call relationship exists in the new-version post-mutation function call sequence”, the method further includes: step 1901.

Step 1901, in response to the existence of the new-version new function call relationship in the new-version post-mutation function call sequence, supplementing the new-version currently-recovered function call relationship by using the new-version new function call relationship.

In this embodiment, since there exists the new-version new function call relationship in the new-version post-mutation function call sequence, the new-version new function call relationship can be used to supplement the new-version currently-recovered function call relationship, so as to obtain a more complete new-version currently-recovered function call relationship, thereby enabling more accurate matching of the old-version functions and the new-version functions.

In some embodiments, after step 901 of “performing a first traversal on the initial test cases, and performing a first operation once each time an initial test case is traversed during the first traversal”, the method further includes step 2001.

Step 2001, repeating the step of matching the plurality of old-version functions with the plurality of new-version functions according to the old-version currently-recovered function call relationship and the new-version currently-recovered function call relationship to obtain a plurality of matched function pairs, the step of determining at least one candidate patch function from a plurality of matched old-version functions according to the old-version currently-recovered function call relationship and the new-version currently-recovered function call relationship, and the step of performing the first traversal on the initial test cases, and performing the first operation once each time an initial test case is traversed during the first traversal, until an end condition of the fuzz testing is met.

In this embodiment, the fuzz testing may be executed for a plurality of rounds until the end condition of the fuzz testing is met. Therefore, during each round of fuzz testing, as long as new code coverage occurs during the running of a mutated test case, the second test case pool can be updated, and as long as a new function call occurs, at least one of the second test case pool and the candidate patch functions can be updated, so as to improve the efficiency of determining the target input data in the next round of fuzz testing. Here, updating of the candidate patch functions requires updating the matched function pairs. Updating of a matched function pair requires updating at least one of the old-version currently-recovered function call relationship and the new-version currently-recovered function call relationship. Therefore, the old-version currently-recovered function call relationship can be updated through each old-version post-mutation function call sequence, and the new-version currently-recovered function call relationship can be updated through each new-version post-mutation function call sequence.

In this embodiment, the end condition of the fuzz testing may be that the number of running rounds of the fuzz testing reaches a preset number, the running time of the fuzz testing reaches preset time, the amount of determined target input data reaches a preset amount, etc., which is not limited here.

### Embodiment 6

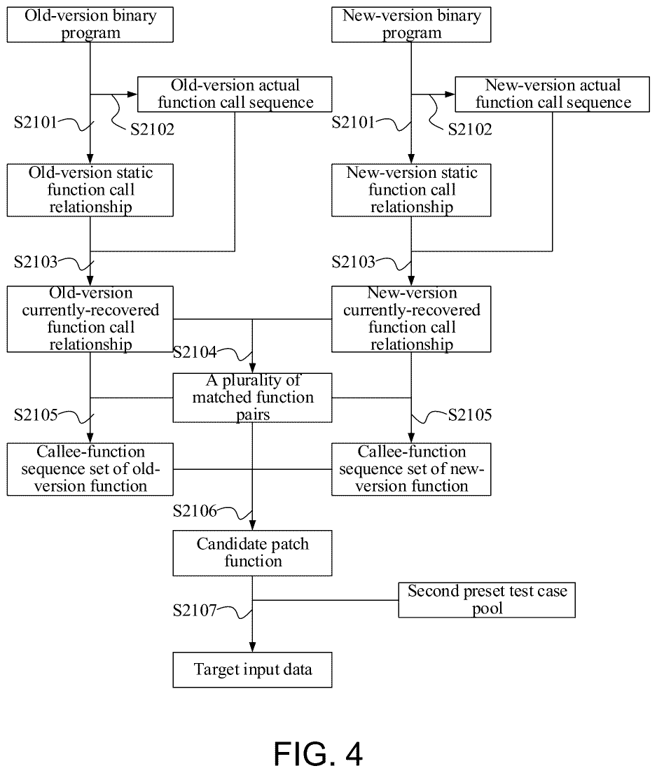

FIG. 4 is a schematic flowchart of a method for reproducing input data that triggers a software vulnerability according to Embodiment 6 of the present application. As shown in FIG. 4, in this embodiment, the method for reproducing input data that triggers a software vulnerability includes steps S2101 to S2107.

Step S2101, an electronic device obtains a plurality of old-version functions and an old-version static function call relationship included in an old-version binary program of target software before a vulnerability is patched, and obtains a plurality of new-version functions and a new-version static function call relationship included in a new-version binary program of the target software after the vulnerability is patched.

Step S2102, the electronic device obtains an old-version actual function call sequence during running of a first test case by the old-version binary program, and obtains a new-version actual function call sequence during running of the first test case by the new-version binary program; where the first test case belongs to a first preset test case pool.

Step S2103, the electronic device determines an old-version currently-recovered function call relationship according to the old-version static function call relationship and the old-version actual function call sequence, and determines a new-version currently-recovered function call relationship according to the new-version static function call relationship and the new-version actual function call sequence.

Step S2104, the electronic device matches the plurality of old-version functions with the plurality of new-version functions according to the old-version currently-recovered function call relationship and the new-version currently-recovered function call relationship, to obtain a plurality of matched function pairs; where a matched function pair includes an old-version function and a new-version function that match each other.

Step S2105, the electronic device determines an old-version callee-function sequence set for the old-version function in each matched function pair according to the old-version currently-recovered function call relationship; and determines a new-version callee-function sequence set for the new-version function in each matched function pair according to the new-version currently-recovered function call relationship.

Step S2106, the electronic device determines the old-version function in a matched function pair to be a candidate patch function, in response to existence of a difference between the old-version callee-function sequence set of the old-version function and the new-version callee-function sequence set of the new-version function in the matched function pair.

Step S2107, the electronic device performs fuzz testing on the old-version binary program and the new-version binary program according to each candidate patch function and a second preset test case pool, to determine target input data that is capable of triggering the vulnerability of the old-version binary program.

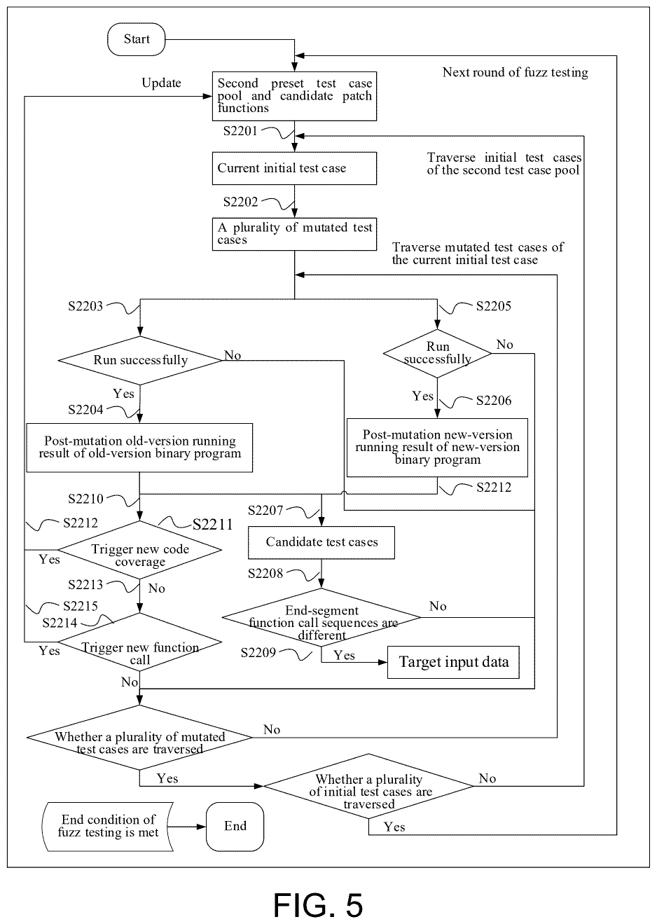

FIG. 5 is a schematic flowchart of fuzz testing in the method for reproducing input data that triggers a software vulnerability according to Embodiment 6 of the present application. As shown in FIG. 5, the fuzz testing includes the following steps.

Step S2201, performing a first traversal on initial test cases, and performing a first operation once each time an initial test case is traversed during the first traversal.

The first operation includes: steps S2202 to S2208.

Step S2202, mutating the current initial test case according to a preset mutation time and a preset mutation method, to obtain a plurality of mutated test cases corresponding to the current initial test case.

Step S2203, using the old-version binary program to run each mutated test case, and determining whether each mutated test case runs successfully in the old-version binary program.

Step S2204, in response to any mutated test case running successfully in the old-version binary program, obtaining an old-version post-mutation function call sequence and an old-version post-mutation program execution path during running of the mutated test case by the old-version binary program.

Step S2205, using the new-version binary program to run each mutated test case, and determining whether each mutated test case runs successfully in the new-version binary program.

Step S2206, in response to any mutated test case running successfully in the new-version binary program, obtaining a new-version post-mutation function call sequence and a new-version post-mutation program execution path during running of the mutated test case by the new-version binary program.

Step S2207, in response to any mutated test case running successfully in both the old-version binary program and the new-version binary program, determining the mutated test case to be a candidate test case.

Step S2208, determining an order for performing a second traversal on candidate test cases according to the old-version post-mutation program execution path corresponding to each candidate test case and the candidate patch function(s), performing the second traversal on the candidate test cases according to the order for performing the second traversal on the candidate test cases, and performing a second operation once each time a candidate test case is traversed during the second traversal.

The second operation includes: step S2209.

Step S2209, determining whether the candidate test case is the target input data according to the old-version post-mutation function call sequence and the new-version post-mutation function call sequence corresponding to the candidate test case.

After step S2204, the method further includes step S2210: for any mutated test case that runs successfully in the old-version binary program or the new-version binary program, performing the following operations.

Step S2211, determining whether the old-version post-mutation program execution path corresponding to the mutated test case triggers new code coverage for the old-version binary program, and whether the corresponding new-version post-mutation program execution path triggers new code coverage for the new-version binary program.

Step S2212, in response to triggering of the new code coverage for the old-version binary program or triggering of the new code coverage for the new-version binary program, adding the mutated test case to the second preset test case pool as an initial test case.

After step S2204, the method further includes step S2213: for any mutated test case that runs successfully in the old-version binary program or the new-version binary program, performing the following operations.

Step S2214, determining whether an old-version new function call relationship that does not exist in the old-version currently-recovered function call relationship exists in the old-version post-mutation function call sequence corresponding to the mutated test case, and whether a new-version new function call relationship that does not exist in the new-version currently-recovered function call relationship exists in the corresponding new-version post-mutation function call sequence.

Step S2215, in response to existence of the old-version new function call relationship or the new-version new function call relationship, adding the mutated test case to the second preset test case pool as an initial test case.

Step S2215 further includes, supplementing the old-version currently-recovered function call relationship by using the old-version new function call relationship to, and/or, supplementing the new-version currently-recovered function call relationship by using the new-version new function call relationship.

It should be noted that the various steps shown in FIG. 4 and FIG. 5 do not constitute a specific limitation of the present application. In other embodiments of the present application, the process of reproducing input data that triggers a software vulnerability may include more or fewer steps than in FIG. 4, the process of fuzz testing may include more or fewer steps than in FIG. 5, some steps in FIG. 4 and FIG. 5 may be replaced by steps with the same function, or, some steps in FIG. 4 and FIG. 5 may be split into a plurality of steps.

### Embodiment 7

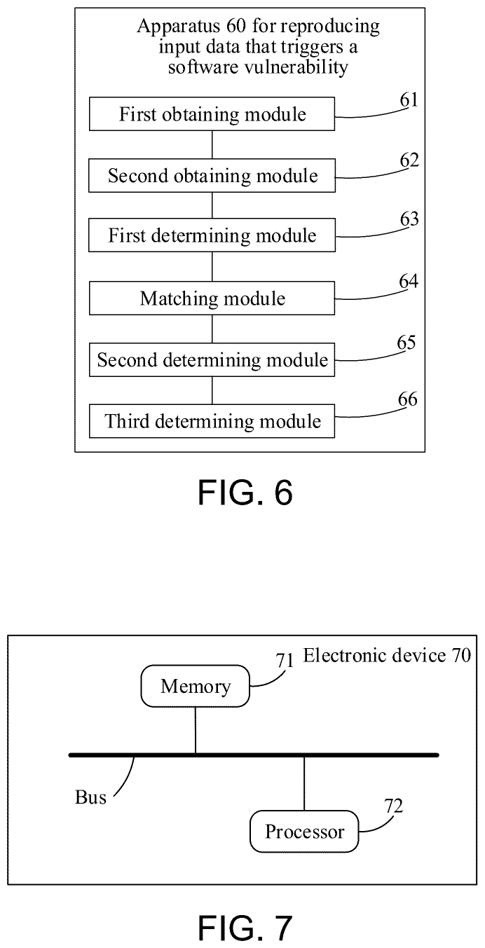

FIG. 6 is a schematic structural diagram of an apparatus for reproducing input data that triggers a software vulnerability according to Embodiment 7 of the present application. As shown in FIG. 6, the apparatus 60 for reproducing input data that triggers a software vulnerability provided in this embodiment includes: a first obtaining module 61, a second obtaining module 62, a first determining module 63, a matching module 64, a second determining module 65, and a third determining module 66.

The first obtaining module 61 is configured to obtain a plurality of old-version functions and an old-version static function call relationship included in an old-version binary program of target software before a vulnerability is patched, and obtain a plurality of new-version functions and a new-version static function call relationship included in a new-version binary program of the target software after the vulnerability is patched.

The second obtaining module 62 is configured to obtain an old-version actual function call sequence during running of a first test case by the old-version binary program, and obtain a new-version actual function call sequence during running of the first test case by the new-version binary program; where the first test case belongs to a first preset test case pool.

The first determining module 63 is configured to determine an old-version currently-recovered function call relationship according to the old-version static function call relationship and the old-version actual function call sequence, and determine a new-version currently-recovered function call relationship according to the new-version static function call relationship and the new-version actual function call sequence.

The matching module 64 is configured to match the plurality of old-version functions with the plurality of new-version functions according to the old-version currently-recovered function call relationship and the new-version currently-recovered function call relationship, to obtain a plurality of matched function pairs; where a matched function pair includes an old-version function and a new-version function that match each other.

The second determining module 65 is configured to determine at least one candidate patch function from a plurality of matched old-version functions according to the old-version currently-recovered function call relationship and the new-version currently-recovered function call relationship.

The third determining module 66 is configured to perform fuzz testing on the old-version binary program and the new-version binary program according to each candidate patch function and a second preset test case pool, to determine target input data that is capable of triggering the vulnerability of the old-version binary program.

In some embodiments, the first obtaining module 61 is specifically configured to: identify the old-version binary program by using a static disassembler program, to obtain the plurality of old-version functions and the old-version static function call relationship; and identify the new-version binary program by using a static disassembler program, to obtain the plurality of new-version functions and the new-version static function call relationship.

In some embodiments, the first determining module 63 is specifically configured to:
supplement the old-version static function call relationship by using an actual function call relationship existing in the old-version actual function call sequence, to obtain the old-version currently-recovered function call relationship; and supplement the new-version static function call relationship by using an actual function call relationship existing in the new-version actual function call sequence, to obtain the new-version currently-recovered function call relationship.

In some embodiments, the matching module 64 is specifically configured to: determine matching information for each old-version function according to the old-version currently-recovered function call relationship; determine matching information for each new-version function according to the new-version currently-recovered function call relationship; and match the plurality of old-version functions with the plurality of new-version functions according to the matching information for each old-version function and the matching information for each new-version function, to obtain a plurality of matched function pairs.

In some embodiments, the matching module 64 is also specifically configured to: match an entry function of the old-version binary program with an entry function of the new-version binary program, to obtain a matched function pair; calculate a matching value between each unmatched old-version function and each unmatched new-version function according to the matching information for each unmatched old-version function and the matching information for each unmatched new-version function; determine a pair of an unmatched old-version function and an unmatched new-version function with the highest matching value to be a matched function pair; and repeat the step of calculating a matching value between each unmatched old-version function and each unmatched new-version function and the step of determining a pair of an unmatched old-version function and an unmatched new-version function with the highest matching value to be a matched function pair, until there is no unmatched old-version functions, or, until there is no unmatched new-version functions, to obtain a plurality of matched function pairs.

In some embodiments, the matching information includes: the number of times being called, the number of times of call initiating, the quantity of each preset call instruction type when initiating calls, a caller function set when being called, and whether a called relationship actually exists. The matching module 64 is also specifically configured to:
for any pair of an unmatched old-version function and an unmatched new-version function, perform the following operations: determining a first matching score according to the number of times being called corresponding to the old-version function and the number of times being called corresponding to the new-version function; determining a second matching score according to the number of times of call initiating corresponding to the old-version function and the number of times of call initiating corresponding to the new-version function; determining a third matching score according to the quantity of each preset call instruction type corresponding to when the old-version function initiates calls and the quantity of each preset call instruction type corresponding to when the new-version function initiates calls; determining a fourth matching score according to the caller function set corresponding to when the old-version function is called and the caller function set corresponding to when the new-version function is called; determining a fifth matching score according to whether the called relationship of the old-version function actually exists and whether the called relationship of the new-version function actually exists; and performing a weighted sum calculation on the first matching score, the second matching score, the third matching score, the fourth matching score, and the fifth matching score according to their corresponding preset weights, to obtain the matching value between the unmatched old-version function and the unmatched new-version function.

In some embodiments, the fourth matching score is a first preset numerical value or a second preset numerical value; the first preset numerical value is greater than the second preset numerical value; in some embodiments, the matching module 64 is also specifically configured to: in response to existence of a matched function pair between the caller function set corresponding to when the old-version function is called and the caller function set corresponding to when the new-version function is called, determine the fourth matching score to be the first preset numerical value; and in response to absence of a matched function pair between the caller function set corresponding to when the old-version function is called and the caller function set corresponding to when the new-version function is called, determine the fourth matching score to be the second preset numerical value.

In some embodiments, the fifth matching score is a third preset numerical value or a fourth preset numerical value; the third preset numerical value is greater than the fourth preset numerical value; in some embodiments, the matching module 64 is also specifically configured to: in response to existence of the called relationship of the old-version function in the old-version actual function call sequence, and existence of the called relationship of the new-version function existing in the new-version actual function call sequence, determine the fifth matching score to be the third preset numerical value; and in response to absence of the called relationship of the old-version function in the old-version actual function call sequence, or, absence of the called relationship of the new-version function in the new-version actual function call sequence, determine the fifth matching score to be the fourth preset numerical value.

In some embodiments, the second determining module 65 is specifically configured to: determine an old-version callee-function sequence set for the old-version function in each matched function pair according to the old-version currently-recovered function call relationship, where the old-version callee-function sequence set includes at least one old-version callee-function sequence, and the old-version callee-function sequence is a sequence of functions called by a function call instruction sequence on a program branch in the old-version function; determine a new-version callee-function sequence set for the new-version function in each matched function pair according to the new-version currently-recovered function call relationship, where the new-version callee-function sequence set includes at least one new-version callee-function sequence, and the new-version callee-function sequence is a sequence of functions called by a function call instruction sequence on a program branch in the new-version function; and in response to existence of a difference between the old-version callee-function sequence set of the old-version function and the new-version callee-function sequence set of the new-version function in a matched function pair, determine the old-version function in the matched function pair to be a candidate patch function.

In some embodiments, the second preset test case pool includes a plurality of initial test cases, and the initial test cases can be successfully run by the new-version binary program and the old-version binary program; the third determining module 66 is specifically configured to: perform a first traversal on the initial test cases, and perform a first operation once each time an initial test case is traversed during the first traversal; where the first operation includes: mutating the initial test case according to a preset mutation time and a preset mutation method, to obtain a plurality of mutated test cases corresponding to the initial test case; using the old-version binary program to run each mutated test case, and determining whether each mutated test case runs successfully in the old-version binary program; in response to any mutated test case running successfully in the old-version binary program, obtaining an old-version post-mutation function call sequence and an old-version post-mutation program execution path during running of the mutated test case by the old-version binary program; using the new-version binary program to run each mutated test case, and determining whether each mutated test case runs successfully in the new-version binary program; in response to any mutated test case running successfully in the new-version binary program, obtaining a new-version post-mutation function call sequence and a new-version post-mutation program execution path during running of the mutated test case by the new-version binary program; in response to any mutated test case running successfully in both the old-version binary program and the new-version binary program, determining the mutated test case to be a candidate test case; determining an order for performing a second traversal on candidate test cases according to the old-version post-mutation program execution path corresponding to each candidate test case and the candidate patch function; performing the second traversal on the candidate test cases according to the order for performing the second traversal on the candidate test cases, and performing a second operation once each time a candidate test case is traversed during the second traversal; where the second operation includes: determining whether the candidate test case is the target input data according to the old-version post-mutation function call sequence and the new-version post-mutation function call sequence corresponding to the candidate test case.

In some embodiments, the third determining module 66 is also specifically configured to: determine an old-version end-segment function call sequence of the old-version post-mutation function call sequence, and determine a new-version end-segment function call sequence of the new-version post-mutation function call sequence; and in response to the old-version end-segment function call sequence being different from the new-version end-segment function call sequence, determine the candidate test case to be the target input data.

In some embodiments, when using the old-version binary program to run each mutated test case, the third determining module 66 is also specifically configured to: use a first circular array to record function calls during running of the mutated test case by the old-version binary program; when determining the old-version end-segment function call sequence of the old-version post-mutation function call sequence, the third determining module 66 is also specifically configured to: determine the function calls recorded in the first circular array to be the old-version end-segment function call sequence according to an order from head to tail; when using the new-version binary program to run each mutated test case, the third determining module 66 is also specifically configured to: use a second circular array to record function calls during running of the mutated test case by the new-version binary program; where the length of the second circular array is the same as the length of the first circular array; and when determining the new-version end-segment function call sequence of the new-version post-mutation function call sequence, the third determining module 66 is also specifically configured to: determine the function calls recorded in the second circular array to be the new-version end-segment function call sequence according to an order from head to tail.

In some embodiments, the third determining module 66 is also specifically configured to: calculate an execution distance between the old-version post-mutation program execution path corresponding to each candidate test case and each candidate patch function; and determine the order for performing the second traversal on the candidate test cases according to the execution distance between the old-version post-mutation program execution path corresponding to each candidate test case and each candidate patch function.

In some embodiments, the third determining module 66 is also specifically configured to: for an old-version post-mutation program execution path and a candidate patch function, obtain a predecessor function of the candidate patch function on the old-version post-mutation program execution path, where the predecessor function exists on the old-version post-mutation program execution path and is the one whose distance of executing to the candidate patch function is shortest among caller functions of the candidate patch function; calculate a first distance of executing from the entry function of the old-version binary program to the predecessor function along the old-version post-mutation program execution path; calculate a second distance of executing from the predecessor function to the candidate patch function; and determine a sum of the first distance and the second distance to be the execution distance between the old-version post-mutation program execution path and the candidate patch function.

In some embodiments, the third determining module 66 is also specifically configured to: perform, for each candidate test case, a summation calculation on execution distances between the old-version post-mutation program execution path and candidate patch functions, to obtain corresponding candidate distances of the candidate test cases; and determine the order for performing the second traversal on the candidate test cases as the ascending order of the corresponding candidate distances.

In some embodiments, the third determining module 66 is also specifically configured to: obtain an old-version initial program execution path corresponding to each initial test case; determine an order for performing the first traversal on the initial test cases according to the old-version initial program execution path corresponding to each initial test case and each candidate patch function; when performing the first traversal on the initial test cases, the third determining module 66 is also specifically configured to: perform the first traversal on the initial test cases according to the order for performing the first traversal on the initial test cases.

In some embodiments, the third determining module 66 is also specifically configured to: for any mutated test case that runs successfully in the old-version binary program, perform the following operations: determining whether the old-version post-mutation program execution path triggers new code coverage for the old-version binary program; and in response to the old-version post-mutation program execution path triggering the new code coverage for the old-version binary program, adding the mutated test case to the second preset test case pool as an initial test case.

In some embodiments, the third determining module 66 is also specifically configured to: for any mutated test case that runs successfully in the old-version binary program, perform the following operations: determining whether an old-version new function call relationship that does not exist in the old-version currently-recovered function call relationship exists in the old-version post-mutation function call sequence; and in response to existence of the old-version new function call relationship in the old-version post-mutation function call sequence, adding the mutated test case to the second preset test case pool as an initial test case.

In some embodiments, the third determining module 66 is also specifically configured to: in response to the existence of the old-version new function call relationship in the old-version post-mutation function call sequence, supplement the old-version currently-recovered function call relationship by using the old-version new function call relationship.

In some embodiments, the third determining module 66 is also specifically configured to: for any mutated test case that runs successfully in the new-version binary program, perform the following operations: determining whether the new-version post-mutation program execution path triggers new code coverage for the new-version binary program; and in response to the new-version post-mutation program execution path triggering the new code coverage for the new-version binary program, adding the mutated test case to the second preset test case pool as an initial test case.

In some embodiments, the third determining module 66 is also specifically configured to: for any mutated test case that runs successfully in the new-version binary program, perform the following operations: determining whether a new-version new function call relationship that does not exist in the new-version currently-recovered function call relationship exists in the new-version post-mutation function call sequence; and in response to existence of the new-version new function call relationship in the new-version post-mutation function call sequence, adding the mutated test case to the second preset test case pool as an initial test case.

In some embodiments, the third determining module 66 is also specifically configured to: in response to the existence of the new-version new function call relationship in the new-version post-mutation function call sequence, supplement the new-version currently-recovered function call relationship by using the new-version new function call relationship.

In some embodiments, the third determining module 66 is also specifically configured to: repeat the step of matching the plurality of old-version functions with the plurality of new-version functions according to the old-version currently-recovered function call relationship and the new-version currently-recovered function call relationship to obtain a plurality of matched function pairs, the step of determining at least one candidate patch function from the plurality of matched old-version functions according to the old-version currently-recovered function call relationship and the new-version currently-recovered function call relationship, and the step of performing the first traversal on the initial test cases and performing the first operation once each time an initial test case is traversed during the first traversal, until an end condition of the fuzz testing is met.

The apparatus for reproducing input data that triggers a software vulnerability provided in this embodiment can execute the method for reproducing input data that triggers a software vulnerability provided in any of the above embodiments. The specific implementations and principles thereof are similar, and will not be repeated here.

### Embodiment 8

FIG. 7 is a schematic structural diagram of an electronic device according to Embodiment 8 of the present application. As shown in FIG. 7, the electronic device 70 provided in this embodiment includes: a processor 72, and a memory 71 communicatively connected to the processor 72.

The memory 71 stores computer-executable instructions.

The processor 72 executes the computer-executable instructions stored in the memory 71 to implement the method for reproducing input data that triggers a software vulnerability as provided in any one of the above embodiments. The specific implementations and principles thereof are similar, and will not be repeated here.

In some embodiments, the electronic device 70 further includes a transceiver. The transceiver is used to send and receive data. The transceiver, the memory, and the processor are interconnected by circuitry.

Communication connections and circuit interconnections between the memory, the processor, and the transceiver can be implemented through a bus. The bus may be an industry standard architecture (ISA) bus, a peripheral component interconnect (PCI) bus, or an extended industry standard architecture (EISA) bus, etc. The bus can be divided into an address bus, a data bus, a control bus, etc. For ease of representation, only a single thick line is used in FIG. 7, but this does not mean that there is only one bus or one type of buses.

The memory 71 may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc, etc.

In an exemplary embodiment, the electronic device 70 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components, for executing the above method for reproducing input data that triggers a software vulnerability.

An embodiment of the present application also provides a computer-readable storage medium, where the computer-readable storage medium stores computer-executable instructions, and the computer-executable instructions are used to implement the method for reproducing input data that triggers a software vulnerability as provided in any one of the above embodiments when executed by a processor. The specific implementations and principles thereof are similar, and will not be repeated here. As an example, the computer-readable storage medium may be a read-only memory (ROM), a random access memory (RAM), a magnetic tape, a floppy disk, and an optical data storage device, etc.

An embodiment of the present application also provides a computer program product, including a computer program, and when the computer program is executed by a processor, the method for reproducing input data that triggers a software vulnerability provided in any one of the above embodiments is implemented. The specific implementations and principles thereof are similar, and will not be repeated here.

An embodiment of the present application also provides a computer program, and when the computer program is executed by a processor, the method for reproducing input data that triggers a software vulnerability provided in any one of the above embodiments is implemented. The specific implementations and principles thereof are similar, and will not be repeated here.

An embodiment of the present application also provides a computer program stored on a computer-readable storage medium, and when the computer program is executed by a processor, the method for reproducing input data that triggers a software vulnerability provided in any one of the above embodiments is implemented. The specific implementations and principles thereof are similar, and will not be repeated here.

It should be understood that the device embodiments described above are merely illustrative, and the devices of the present application may also be implemented in other ways. For example, the division of modules in the above embodiments is merely a division of logical functions, and there may be other division methods in actual implementation. For example, a plurality of modules may be combined or integrated into another system, or some features may be ignored or not executed. In addition, unless otherwise specified, the functional modules in the various embodiments of the present application may be integrated into one module, or each module may exist physically alone, or two or more modules may be integrated together. The integrated modules described above can be implemented in the form of hardware, or in the form of software program modules.

It should be noted that for the foregoing method embodiments, for the sake of simple description, they are all expressed as a series of action combinations, but a person skilled in the art should know that the present application is not limited by the described sequence of actions, since according to the present application, certain steps may be performed in other orders or simultaneously. Secondly, a person skilled in the art should also know that the embodiments described in the description are some embodiments, and the actions and modules involved are not necessarily required by the present application. Although the various steps in a flowchart are shown in sequence as indicated by the arrows, these steps are not necessarily executed sequentially in the order indicated by the arrows. Unless explicitly stated herein, the execution of these steps is not strictly limited in sequence, and these steps may be executed in other orders. Moreover, at least part of the steps in the flowcharts may include a plurality of sub-steps or a plurality of stages, and these sub-steps or stages are not necessarily completed at the same time, but may be executed at different times. The execution order of these sub-steps or stages is not necessarily sequential, but may be performed in turn or alternately with other steps or at least part of the sub-steps or stages of other steps.

Herein, step codes such as 201, 202, 203a, 203b are used. Their purpose is to describe the corresponding content more clearly and briefly, and they do not constitute a substantial limitation on the order. In specific implementations, a person skilled in the art may execute step 202 after executing step 201, or execute step 203a and step 203b simultaneously, etc., and these should all be within the protection scope of the present application.

A person skilled in the art will readily think of other embodiments of the present application after considering the description and practicing the disclosure. The present application is intended to cover any variations, uses, or adaptations of the present application, which follow the general principles of the present application and include common knowledge or conventional technical means in this technical field that is not disclosed in the present application. The description and the embodiments are to be regarded as exemplary only, and the true scope and spirit of the present application are indicated by the following claims.

It should be understood that the present application is not limited to the precise structures that have been described above and shown in the drawings, and that various modifications and changes can be made without departing from its scope. The scope of the present application is limited only by the appended claims.

What is claimed is:

1. A method for reproducing input data that triggers a software vulnerability, comprising:
obtaining a plurality of old-version functions and an old-version static function call relationship comprised in an old-version binary program of target software before a vulnerability is patched, and obtaining a plurality of new-version functions and a new-version static function call relationship comprised in a new-version binary program of the target software after the vulnerability is patched;
obtaining an old-version actual function call sequence during running of a first test case by the old-version binary program, and obtaining a new-version actual function call sequence during running of the first test case by the new-version binary program; wherein the first test case belongs to a first preset test case pool;
determining an old-version currently-recovered function call relationship according to the old-version static function call relationship and the old-version actual function call sequence, and determining a new-version currently-recovered function call relationship according to the new-version static function call relationship and the new-version actual function call sequence;
matching the plurality of old-version functions with the plurality of new-version functions according to the old-version currently-recovered function call relationship and the new-version currently-recovered function call relationship, to obtain a plurality of matched function pairs; wherein a matched function pair comprises an old-version function and a new-version function that match each other;
determining at least one candidate patch function from a plurality of matched old-version functions according to the old-version currently-recovered function call relationship and the new-version currently-recovered function call relationship;
performing fuzz testing on the old-version binary program and the new-version binary program according to each candidate patch function and a second preset test case pool, to determine target input data that is capable of triggering the vulnerability of the old-version binary program.

2. The method according to claim 1, wherein the obtaining the plurality of old-version functions and the old-version static function call relationship comprised in the old-version binary program of the target software before the vulnerability is patched comprises:
identifying the old-version binary program by using a static disassembler program, to obtain the plurality of old-version functions and the old-version static function call relationship;
wherein the obtaining the plurality of new-version functions and the new-version static function call relationship comprised in the new-version binary program of the target software after the vulnerability is patched comprises:
identifying the new-version binary program by using the static disassembler program, to obtain the plurality of new-version functions and the new-version static function call relationship.

3. The method according to claim 1, wherein the determining the old-version currently-recovered function call relationship according to the old-version static function call relationship and the old-version actual function call sequence comprises:
supplementing the old-version static function call relationship by using an actual function call relationship existing in the old-version actual function call sequence, to obtain the old-version currently-recovered function call relationship;
wherein the determining the new-version currently-recovered function call relationship according to the new-version static function call relationship and the new-version actual function call sequence comprises:
supplementing the new-version static function call relationship by using an actual function call relationship existing in the new-version actual function call sequence, to obtain the new-version currently-recovered function call relationship.

4. The method according to claim 1, wherein the matching the plurality of old-version functions with the plurality of new-version functions according to the old-version currently-recovered function call relationship and the new-version currently-recovered function call relationship, to obtain the plurality of matched function pairs, comprises:
determining matching information for each old-version function according to the old-version currently-recovered function call relationship;
determining matching information for each new-version function according to the new-version currently-recovered function call relationship;
matching the plurality of old-version functions with the plurality of new-version functions according to the matching information for each old-version function and the matching information for each new-version function, to obtain a plurality of matched function pairs.

5. The method according to claim 4, wherein the matching the plurality of old-version functions with the plurality of new-version functions according to the matching information for each old-version function and the matching information for each new-version function, to obtain the plurality of matched function pairs, comprises:
matching an entry function of the old-version binary program with an entry function of the new-version binary program, to obtain a matched function pair;
calculating a matching value between each unmatched old-version function and each unmatched new-version function according to the matching information for each unmatched old-version function and the matching information for each unmatched new-version function;
determining a pair of an unmatched old-version function and an unmatched new-version function with a highest matching value to be a matched function pair;
repeating the step of calculating a matching value between each unmatched old-version function and each unmatched new-version function and the step of determining a pair of an unmatched old-version function and an unmatched new-version function with a highest matching value to be a matched function pair, until there is no unmatched old-version function, or, until there is no unmatched new-version function, to obtain a plurality of matched function pairs.

6. The method according to claim 5, wherein the matching information comprises: a number of times being called, a number of times of call initiating, a quantity of each preset call instruction type when initiating calls, a caller function set when being called, and whether a called relationship actually exists;
wherein the calculating the matching value between each unmatched old-version function and each unmatched new-version function according to the matching information for each unmatched old-version function and the matching information for each unmatched new-version function comprises:
for any pair of an unmatched old-version function and an unmatched new-version function, performing the following operations:
determining a first matching score according to the number of times being called corresponding to the old-version function and the number of times being called corresponding to the new-version function;
determining a second matching score according to the number of times of call initiating corresponding to the old-version function and the number of times of call initiating corresponding to the new-version function;
determining a third matching score according to the quantity of each preset call instruction type corresponding to when the old-version function initiates calls and the quantity of each preset call instruction type corresponding to when the new-version function initiates calls;
determining a fourth matching score according to the caller function set corresponding to when the old-version function is called and the caller function set corresponding to when the new-version function is called;
determining a fifth matching score according to whether the called relationship of the old-version function actually exists and whether the called relationship of the new-version function actually exists;
performing a weighted sum calculation on the first matching score, the second matching score, the third matching score, the fourth matching score, and the fifth matching score according to corresponding preset weights thereof, to obtain the matching value between the unmatched old-version function and the unmatched new-version function.

7. The method according to claim 6, wherein the fourth matching score is a first preset numerical value or a second preset numerical value; the first preset numerical value is greater than the second preset numerical value;
wherein the determining the fourth matching score according to the caller function set corresponding to when the old-version function is called and the caller function set corresponding to when the new-version function is called comprises:
in response to existence of a matched function pair between the caller function set corresponding to when the old-version function is called and the caller function set corresponding to when the new-version function is called, determining the fourth matching score to be the first preset numerical value;
in response to absence of a matched function pair between the caller function set corresponding to when the old-version function is called and the caller function set corresponding to when the new-version function is called, determining the fourth matching score to be the second preset numerical value.

8. The method according to claim 6, wherein the fifth matching score is a third preset numerical value or a fourth preset numerical value; the third preset numerical value is greater than the fourth preset numerical value;
wherein the determining the fifth matching score according to whether the called relationship of the old-version function actually exists and whether the called relationship of the new-version function actually exists comprises:
in response to existence of the called relationship of the old-version function in the old-version actual function call sequence, and existence of the called relationship of the new-version function in the new-version actual function call sequence, determining the fifth matching score to be the third preset numerical value;
in response to absence of the called relationship of the old-version function in the old-version actual function call sequence, or, absence of the called relationship of the new-version function in the new-version actual function call sequence, determining the fifth matching score to be the fourth preset numerical value.

9. The method according to claim 1, wherein the determining at least one candidate patch function from the plurality of matched old-version functions according to the old-version currently-recovered function call relationship and the new-version currently-recovered function call relationship comprises:
determining an old-version callee-function sequence set for the old-version function in each matched function pair according to the old-version currently-recovered function call relationship; wherein the old-version callee-function sequence set comprises at least one old-version callee-function sequence, and the old-version callee-function sequence is a sequence of functions called by a function call instruction sequence on a program branch in the old-version function;
determining a new-version callee-function sequence set for the new-version function in each matched function pair according to the new-version currently-recovered function call relationship; wherein the new-version callee-function sequence set comprises at least one new-version callee-function sequence, and the new-version callee-function sequence is a sequence of functions called by a function call instruction sequence on a program branch in the new-version function;
in response to existence of a difference between the old-version callee-function sequence set of the old-version function and the new-version callee-function sequence set of the new-version function in a matched function pair, determining the old-version function in the matched function pair to be a candidate patch function.

10. The method according to claim 1, wherein the second preset test case pool comprises a plurality of initial test cases, and the initial test cases are capable of being successfully run by the new-version binary program and the old-version binary program;
wherein the performing fuzz testing on the old-version binary program and the new-version binary program according to each candidate patch function and the second preset test case pool, to determine the target input data that is capable of triggering the vulnerability of the old-version binary program, comprises:
performing a first traversal on the initial test cases, and performing a first operation once each time an initial test case is traversed during the first traversal;
wherein the first operation comprises:
mutating the initial test case according to a preset mutation time and a preset mutation method, to obtain a plurality of mutated test cases corresponding to the initial test case;
using the old-version binary program to run each mutated test case, and determining whether each mutated test case runs successfully in the old-version binary program;
in response to any mutated test case running successfully in the old-version binary program, obtaining an old-version post-mutation function call sequence and an old-version post-mutation program execution path during running of the mutated test case by the old-version binary program;
using the new-version binary program to run each mutated test case, and determining whether each mutated test case runs successfully in the new-version binary program;
in response to any mutated test case running successfully in the new-version binary program, obtaining a new-version post-mutation function call sequence and a new-version post-mutation program execution path during running of the mutated test case by the new-version binary program;
in response to any mutated test case running successfully in both the old-version binary program and the new-version binary program, determining the mutated test case to be a candidate test case;
determining an order for performing a second traversal on candidate test cases according to the old-version post-mutation program execution path corresponding to each candidate test case and the candidate patch function;
performing the second traversal on the candidate test cases according to the order for performing the second traversal on the candidate test cases, and performing a second operation once each time a candidate test case is traversed during the second traversal;
wherein the second operation comprises:
determining whether the candidate test case is the target input data according to the old-version post-mutation function call sequence and the new-version post-mutation function call sequence corresponding to the candidate test case.

11. The method according to claim 10, wherein the determining whether the candidate test case is the target input data according to the old-version post-mutation function call sequence and the new-version post-mutation function call sequence corresponding to the candidate test case comprises:
determining an old-version end-segment function call sequence of the old-version post-mutation function call sequence, and determining a new-version end-segment function call sequence of the new-version post-mutation function call sequence;
in response to the old-version end-segment function call sequence being different from the new-version end-segment function call sequence, determining the candidate test case to be the target input data;
wherein the using the old-version binary program to run each mutated test case comprises:
using a first circular array to record function calls during running of the mutated test case by the old-version binary program;
wherein the determining the old-version end-segment function call sequence of the old-version post-mutation function call sequence comprises:
determining the function calls recorded in the first circular array to be the old-version end-segment function call sequence according to an order from head to tail;
wherein the using the new-version binary program to run each mutated test case comprises:
using a second circular array to record function calls during running of the mutated test case by the new-version binary program; wherein a length of the second circular array is the same as a length of the first circular array;
wherein the determining the new-version end-segment function call sequence of the new-version post-mutation function call sequence comprises:
determining the function calls recorded in the second circular array to be the new-version end-segment function call sequence according to an order from head to tail.

12. The method according to claim 10, wherein the determining the order for performing the second traversal on the candidate test cases according to the old-version post-mutation program execution path corresponding to each candidate test case and the candidate patch function comprises:
calculating an execution distance between the old-version post-mutation program execution path corresponding to each candidate test case and each candidate patch function;
determining the order for performing the second traversal on the candidate test cases according to the execution distance between the old-version post-mutation program execution path corresponding to each candidate test case and each candidate patch function.

13. The method according to claim 12, wherein the calculating the execution distance between the old-version post-mutation program execution path corresponding to each candidate test case and each candidate patch function comprises:
for an old-version post-mutation program execution path and a candidate patch function, obtaining a predecessor function of the candidate patch function on the old-version post-mutation program execution path; wherein the predecessor function exists on the old-version post-mutation program execution path and is the one whose distance of executing to the candidate patch function is shortest among caller functions of the candidate patch function;
calculating a first distance of executing from an entry function of the old-version binary program to the predecessor function along the old-version post-mutation program execution path;
calculating a second distance of executing from the predecessor function to the candidate patch function;
determining a sum of the first distance and the second distance to be the execution distance between the old-version post-mutation program execution path and the candidate patch function;
wherein the determining the order for performing the second traversal on the candidate test cases according to the execution distance between the old-version post-mutation program execution path corresponding to each candidate test case and each candidate patch function comprises:
performing, for each candidate test case, a summation calculation on execution distances between the old-version post-mutation program execution path and candidate patch functions, to obtain corresponding candidate distances of the candidate test cases;
determining the order for performing the second traversal on the candidate test cases as an ascending order of the corresponding candidate distances.

14. The method according to claim 10, wherein before performing the first traversal on the initial test cases, and performing the first operation once each time an initial test case is traversed during the first traversal, the method further comprises:
obtaining an old-version initial program execution path corresponding to each initial test case;
determining an order for performing the first traversal on the initial test cases according to the old-version initial program execution path corresponding to each initial test case and each candidate patch function;
wherein the performing the first traversal on the initial test cases comprises:
performing the first traversal on the initial test cases according to the order for performing the first traversal on the initial test cases.

15. The method according to claim 10, wherein after in response to any mutated test case running successfully in the old-version binary program, obtaining the old-version post-mutation function call sequence and the old-version post-mutation program execution path during running of the mutated test case by the old-version binary program, the method further comprises:
for any mutated test case that runs successfully in the old-version binary program, performing the following operations:
determining whether the old-version post-mutation program execution path triggers new code coverage for the old-version binary program;
in response to the old-version post-mutation program execution path triggering the new code coverage for the old-version binary program, adding the mutated test case to the second preset test case pool as an initial test case.

16. The method according to claim 10, wherein after in response to any mutated test case running successfully in the old-version binary program, obtaining the old-version post-mutation function call sequence and the old-version post-mutation program execution path during running of the mutated test case by the old-version binary program, the method further comprises:
for any mutated test case that runs successfully in the old-version binary program, performing the following operations:
determining whether an old-version new function call relationship that does not exist in the old-version currently-recovered function call relationship exists in the old-version post-mutation function call sequence;
in response to existence of the old-version new function call relationship in the old-version post-mutation function call sequence, adding the mutated test case to the second preset test case pool as an initial test case;
wherein after determining whether the old-version new function call relationship that does not exist in the old-version currently-recovered function call relationship exists in the old-version post-mutation function call sequence, the method further comprises:
in response to the existence of the old-version new function call relationship in the old-version post-mutation function call sequence, supplementing the old-version currently-recovered function call relationship by using the old-version new function call relationship;
wherein after performing the first traversal on the initial test cases, and performing the first operation once each time an initial test case is traversed during the first traversal, the method further comprises:
repeating the step of matching the plurality of old-version functions with the plurality of new-version functions according to the old-version currently-recovered function call relationship and the new-version currently-recovered function call relationship to obtain a plurality of matched function pairs, the step of determining at least one candidate patch function from a plurality of matched old-version functions according to the old-version currently-recovered function call relationship and the new-version currently-recovered function call relationship, and the step of performing the first traversal on the initial test cases, and performing the first operation once each time an initial test case is traversed during the first traversal, until an end condition of the fuzz testing is met.

17. The method according to claim 10, wherein after in response to any mutated test case running successfully in the new-version binary program, obtaining the new-version post-mutation function call sequence and the new-version post-mutation program execution path during running of the mutated test case by the new-version binary program, the method further comprises:
for any mutated test case that runs successfully in the new-version binary program, performing the following operations:
determining whether the new-version post-mutation program execution path triggers new code coverage for the new-version binary program;
in response to the new-version post-mutation program execution path triggering the new code coverage for the new-version binary program, adding the mutated test case to the second preset test case pool as an initial test case.

18. The method according to claim 10, wherein after in response to any mutated test case running successfully in the new-version binary program, obtaining the new-version post-mutation function call sequence and the new-version post-mutation program execution path during running of the mutated test case by the new-version binary program, the method further comprises:
for any mutated test case that runs successfully in the new-version binary program, performing the following operations:
determining whether a new-version new function call relationship that does not exist in the new-version currently-recovered function call relationship exists in the new-version post-mutation function call sequence;
in response to existence of the new-version new function call relationship in the new-version post-mutation function call sequence, adding the mutated test case to the second preset test case pool as an initial test case;
wherein after determining whether the new-version new function call relationship that does not exist in the new-version currently-recovered function call relationship exists in the new-version post-mutation function call sequence, the method further comprises:
in response to the existence of the new-version new function call relationship in the new-version post-mutation function call sequence, supplementing the new-version currently-recovered function call relationship by using the new-version new function call relationship;
wherein after performing the first traversal on the initial test cases, and performing the first operation once each time an initial test case is traversed during the first traversal, the method further comprises:
repeating the step of matching the plurality of old-version functions with the plurality of new-version functions according to the old-version currently-recovered function call relationship and the new-version currently-recovered function call relationship to obtain a plurality of matched function pairs, the step of determining at least one candidate patch function from a plurality of matched old-version functions according to the old-version currently-recovered function call relationship and the new-version currently-recovered function call relationship, and the step of performing the first traversal on the initial test cases, and performing the first operation once each time an initial test case is traversed during the first traversal, until an end condition of the fuzz testing is met.

19. An electronic device, comprising: a processor, and a memory communicatively connected to the processor; wherein,
the memory stores computer-executable instructions;
when the computer-executable instructions stored in the memory are executed by the processor, the processor is configured to:
obtain a plurality of old-version functions and an old-version static function call relationship comprised in an old-version binary program of target software before a vulnerability is patched, and obtain a plurality of new-version functions and a new-version static function call relationship comprised in a new-version binary program of the target software after the vulnerability is patched;
obtain an old-version actual function call sequence during running of a first test case by the old-version binary program, and obtain a new-version actual function call sequence during running of the first test case by the new-version binary program; wherein the first test case belongs to a first preset test case pool;
determine an old-version currently-recovered function call relationship according to the old-version static function call relationship and the old-version actual function call sequence, and determine a new-version currently-recovered function call relationship according to the new-version static function call relationship and the new-version actual function call sequence;
match the plurality of old-version functions with the plurality of new-version functions according to the old-version currently-recovered function call relationship and the new-version currently-recovered function call relationship, to obtain a plurality of matched function pairs; wherein a matched function pair comprises an old-version function and a new-version function that match each other;
determine at least one candidate patch function from a plurality of matched old-version functions according to the old-version currently-recovered function call relationship and the new-version currently-recovered function call relationship;
perform fuzz testing on the old-version binary program and the new-version binary program according to each candidate patch function and a second preset test case pool, to determine target input data that is capable of triggering the vulnerability of the old-version binary program.

20. A non-transitory computer-readable storage medium, wherein the non-transitory computer-readable storage medium stores computer-executable instructions, and the computer-executable instructions, when executed by a processor, cause the processor to:
obtain a plurality of old-version functions and an old-version static function call relationship comprised in an old-version binary program of target software before a vulnerability is patched, and obtain a plurality of new-version functions and a new-version static function call relationship comprised in a new-version binary program of the target software after the vulnerability is patched;
obtain an old-version actual function call sequence during running of a first test case by the old-version binary program, and obtain a new-version actual function call sequence during running of the first test case by the new-version binary program; wherein the first test case belongs to a first preset test case pool;
determine an old-version currently-recovered function call relationship according to the old-version static function call relationship and the old-version actual function call sequence, and determine a new-version currently-recovered function call relationship according to the new-version static function call relationship and the new-version actual function call sequence;
match the plurality of old-version functions with the plurality of new-version functions according to the old-version currently-recovered function call relationship and the new-version currently-recovered function call relationship, to obtain a plurality of matched function pairs; wherein a matched function pair comprises an old-version function and a new-version function that match each other;
determine at least one candidate patch function from a plurality of matched old-version functions according to the old-version currently-recovered function call relationship and the new-version currently-recovered function call relationship;
perform fuzz testing on the old-version binary program and the new-version binary program according to each candidate patch function and a second preset test case pool, to determine target input data that is capable of triggering the vulnerability of the old-version binary program.
